(19) United States
(12) Patent Application Publication
(10) Pub. No.: US 2015/0085840 A1
(43) Pub. Date: Mar. 26, 2015

(54) TIME DIVISION LONG TERM EVOLUTION (TD-LTE) FRAME STRUCTURE

(71) Applicant: QUALCOMM Incorporated, San Diego, CA (US)

(72) Inventors: Ruoheng Liu, San Diego, CA (US); June Namgoong, San Diego, CA (US); Venkatraman Rajagopalan, San Diego, CA (US); Srikant Jayaraman, San Diego, CA (US)

(21) Appl. No.: 14/461,241

(22) Filed: Aug. 15, 2014

Related U.S. Application Data
(60) Provisional application No. 61/883,169, filed on Sep. 26, 2013.

(51) Int. Cl. H04L 5/00; H04J 3/02

(52) U.S. Cl. CPC H04L 5/0048; H04L 5/0055; H04J 3/02
USPC 370/336

(57) ABSTRACT

A method of wireless communication includes communicating with a base station using a special subframe that extends a guard period over an uplink pilot time slot and one or more disabled, adjacent uplink subframes. The method also includes associating a control information subframe with a specific downlink subframe while accounting for both cell radius extension and loss of the one or more disabled, adjacent uplink subframes used to communicate the extended special subframe.

### CROSS-REFERENCE TO RELATED APPLICATION

The present application claims the benefit of U.S. Provisional Patent Application No. 61/883,169 filed on Sep. 26, 2013, in the names of Ruoheng LIU, et al., the disclosure of which is expressly incorporated by reference herein in its entirety.

### BACKGROUND

1. Field

Aspects of the present disclosure relate generally to wireless communication systems, and more particularly to modification of a time division long term evolution (TD-LTE) frame structure.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

In one aspect, a method of wireless communication is disclosed. The method includes communicating with a base station using a special subframe that extends a guard period over an uplink pilot time slot and one or more disabled, adjacent uplink subframes. The method also includes associating a control information subframe with a specific downlink subframe while accounting for both cell radius extension and loss of the one or more disabled, adjacent uplink subframes used to communicate the extended special subframe.

In another aspect, a method of wireless communication is disclosed. The method includes communicating with a user equipment (UE) using a special subframe that extends over a guard period over an uplink pilot time slot and one or more disabled, adjacent uplink subframes. The method also includes associating control information of a specific subframe with an uplink subframe while accounting for both cell radius extension and loss of the one or more disabled, adjacent uplink subframes used to communicate the extended special subframe.

Another aspect discloses a wireless communication apparatus having a memory and at least one processor coupled to the memory. The processor(s) is configured to communicate with a base station using a special subframe that extends a guard period over an uplink pilot time slot and one or more disabled, adjacent uplink subframes. The processor(s) is also configured to associate a control information subframe with a specific downlink subframe while accounting for both cell radius extension and loss of the one or more disabled, adjacent uplink subframes used to communicate the extended special subframe.

Another aspect discloses a wireless communication apparatus having a memory and at least one processor coupled to the memory. The processor(s) is configured to communicate with a user equipment (UE) using a special subframe that extends over a guard period over an uplink pilot time slot and one or more disabled, adjacent uplink subframes. The processor(s) is also configured to associate control information of a specific subframe with an uplink subframe while accounting for both cell radius extension and loss of the one or more disabled, adjacent uplink subframes used to communicate the extended special subframe.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIG. 7 is a block diagram conceptually illustrating an example of an air to ground communication system according to an aspect of the present disclosure.

FIG. 8 is a diagram conceptually illustrating an example of an aircraft antenna system according to an aspect of the present disclosure.

FIG. 9 is a block diagram showing how timing advance coordinates communications of user equipments (UEs) positioned at different distances from a base station.

FIG. 10 is a timing diagram in which a guard period (T_{GP}) prevents overlap between downlink and uplink communications at UE.

FIG. 11 is a timing diagram in which a duration of a guard period (T_{GP}) is insufficient, resulting in an overlap between downlink and uplink communications at a base station.

FIG. 12 is a block diagram illustrating conventional TD-LTE radio frame configurations.

FIG. 13 is a table illustrating special subframe component lengths according to the various special subframe configurations based on a normal cyclic prefix (CP).

FIG. 14 illustrates a time-domain resource allocation of synchronization and broadcast channels within the subframes of a TD-LTE radio frame structure.

FIG. 15 is a block diagram illustrating a modified radio frame structure according one aspect of the present disclosure.

FIGS. 16A and 16B are block diagrams illustrating configurations of a TD-LTE radio frame structure with a first extended special subframe to support a first extended cell radius according one aspect of the present disclosure.

FIGS. 17A and 17B are block diagrams illustrating other configurations of a TD-LTE radio frame structure with a first extended special subframe to support the first extended cell radius according one aspect of the present disclosure.

FIGS. 18A and 18B are block diagrams illustrating configurations of a TD-LTE radio frame structure with a second extended special subframe to support a second extended cell radius according one aspect of the present disclosure.

FIGS. 19A and 19B are block diagrams illustrating other configurations of a TD-LTE radio frame structure with a second extended special subframe to support a second extended cell radius according one aspect of the present disclosure.

FIG. 20 is a table of the guard time overhead associated with a next generation air to ground (AG) system configuration for supporting the first extended cell radius and the second extend cell radius as compared to a conventional (non-extended) cell radius.

FIG. 21 illustrates categorization of an air cell in multiple zones to support extended cell radii according to one aspect of the present disclosure.

FIGS. 22A and 22B are block diagram illustrating nested frame structures according to one aspect of the present disclosure.

FIG. 23 further illustrates categorization of an air cell in multiple zones to support extended cell radii according to another aspect of the present disclosure.

FIG. 24 is a table illustrating a maximum downlink hybrid automatic repeat request (HARQ) processes based on a next generation AG system configuration according to an aspect of the present disclosure.

FIGS. 25A and 25B illustrate configurations of a time division long term evolution (TD-LTE) radio frame structure including tables of downlink association set indexes, which represent the timing of acknowledgement (ACK)/negative acknowledgement (NACK) feedback when communicating with an extended special subframe according to an aspect of the present disclosure.

FIGS. 26A and 26B are tables illustrating a downlink HARQ processes and timing, which may be used for determining downlink association set index k, i.e., the timing of acknowledgement (ACK)/negative acknowledgement (NACK) feedback in a next generation AG system according to an aspect of the present disclosure.

FIG. 27 is a table illustrating a uplink hybrid automatic repeat request (HARQ) processes based on a next generation AG system configuration according to another aspect of the present disclosure.

FIGS. 28A and 28B illustrate configurations of time division long term evolution (TD-LTE) radio frame structures including tables of uplink association indexes, which represent the timing of physical uplink shared channel (PUSCH) transmission when communicating with an extended special subframe according to another aspect of the present disclosure

FIGS. 29A and 29B illustrate configurations of a time division long term evolution (TD-LTE) radio frame structure including the timing of uplink grants transmitted by a base station and the relative timing of the associated physical uplink shared channel (PUSCH) transmission when communicating with an extended special subframe according to another aspect of the present disclosure.

FIGS. 30A and 30B illustrate configurations of time division long term evolution (TD-LTE) radio frame structures including the timing of physical HARQ indicator channel (PHICH) and the relative timing of the corresponded physical uplink shared channel (PUSCH) transmission when communicating with an extended special subframe according to another aspect of the present disclosure.

FIGS. 31A and 31B illustrate configurations of time division long term evolution (TD-LTE) radio frame structures including the factor mᵢ of the number of physical HARQ indicator channel (PHICH) groups for each downlink subframe when communicating with an extended special subframe according to another aspect of the present disclosure.

FIG. 32 is a flow diagram illustrating a method for modification of a time division long term evolution (TD-LTE) frame structure according to one aspect of the present disclosure.

FIG. 33 is a flow diagram illustrating a method for modification of a time division long term evolution (TD-LTE) frame structure according to another aspect of the present disclosure.

FIG. 34 is a block diagram illustrating different modules, means and/or components in an exemplary apparatus.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

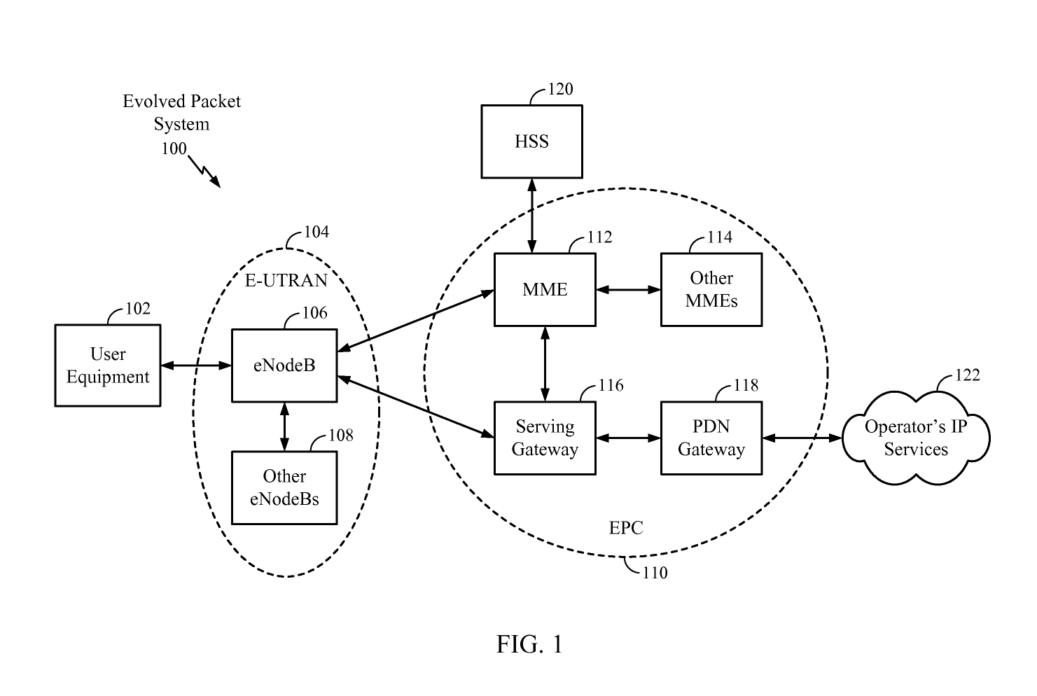

FIG. 1 is a diagram illustrating an LTE network architecture 100. The LTE network architecture 100 may be referred to as an Evolved Packet System (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) Gateway 118. The MME 112 is the control node that processes the signaling between the UE 102 and the EPC 110. Generally, the MME 112 provides bearer and connection management. All user IP packets are transferred through the serving gateway 116, which itself is connected to the PDN Gateway 118. The PDN Gateway 118 provides UE IP address allocation as well as other functions. The PDN Gateway 118 is connected to the Operator's IP Services 122. The operator's IP services 122 may include the Internet, the Intranet, an IP multimedia subsystem (IMS), and a PS streaming service (PSS).

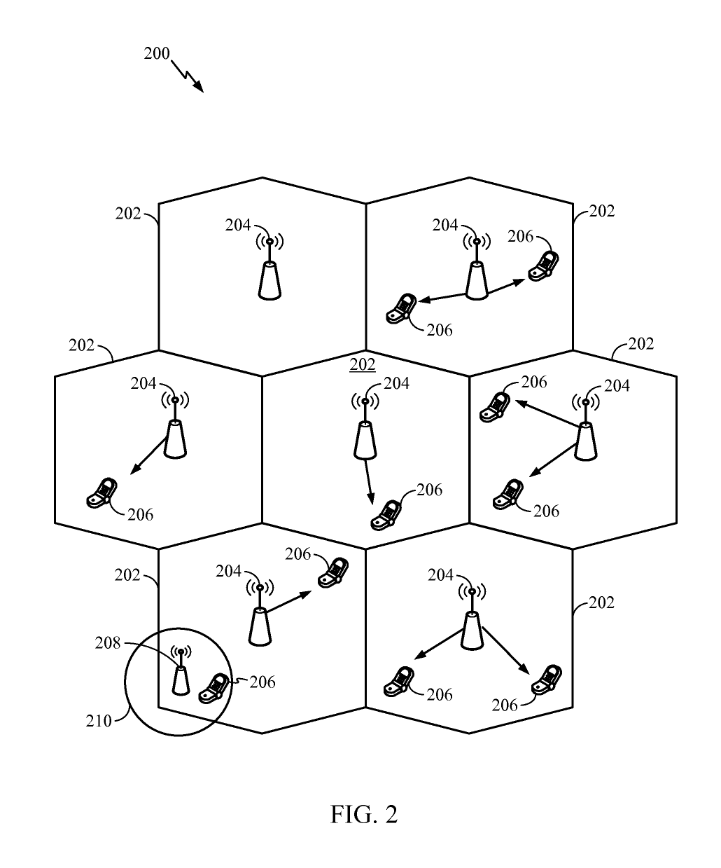

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be a remote radio head (RRH), a femto cell (e.g., home eNodeB (HeNB)), a pico cell, or a micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to evolution-data optimized (EV-DO) or ultra mobile broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to universal terrestrial radio access (UTRA) employing wideband-CDMA (W-CDMA) and other variants of CDMA, such as TD-SCDMA; global system for mobile communications (GSM) employing TDMA; and evolved UTRA (E-UTRA), ultra mobile broadband (UMB), IEEE 802.11 (Wi-Fi), IEEE 802.16 (WiMAX), IEEE 802.20, and flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

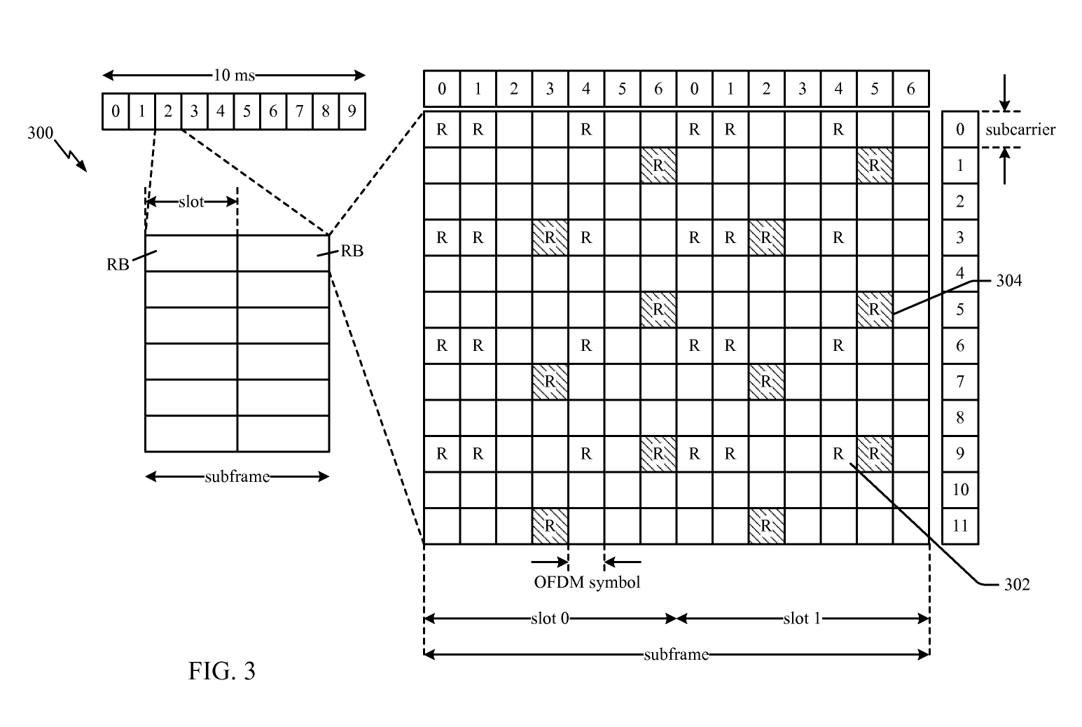

FIG. 3 is a diagram 300 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, for a total of 84 resource elements. For an extended cyclic prefix, a resource block contains 6 consecutive OFDM symbols in the time domain, resulting in 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

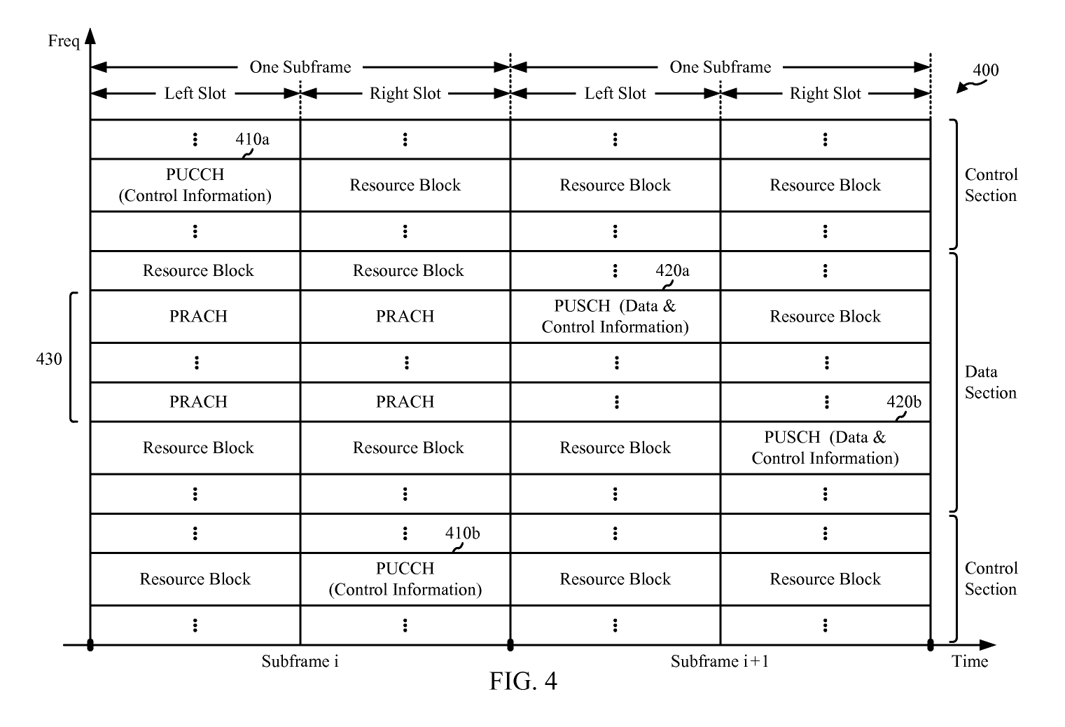

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

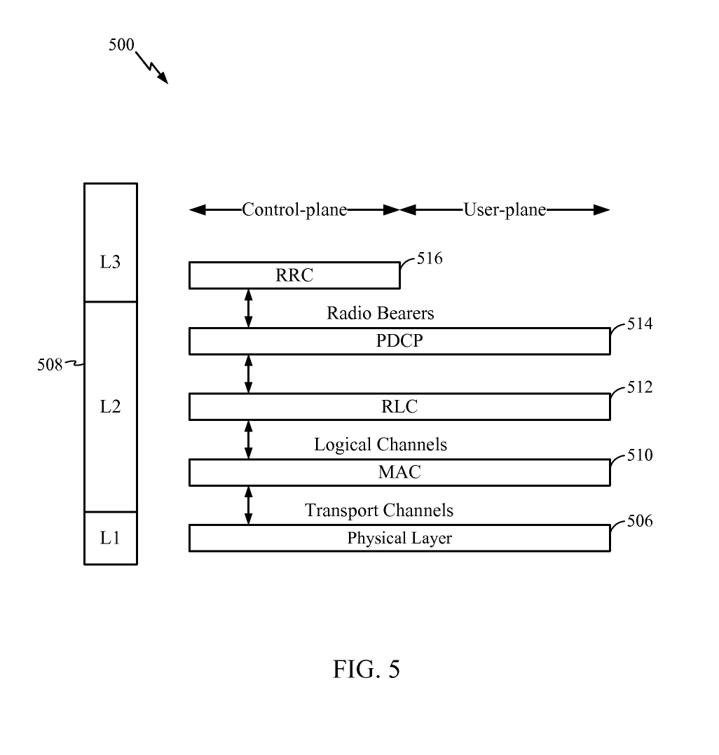

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The radio link control (RLC) sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The radio resource control (RRC) sublayer 516 is responsible for obtaining radio resources (i.e., radio bearers) and for configuring the lower layers using radio resource control signaling between the eNodeB and the UE.

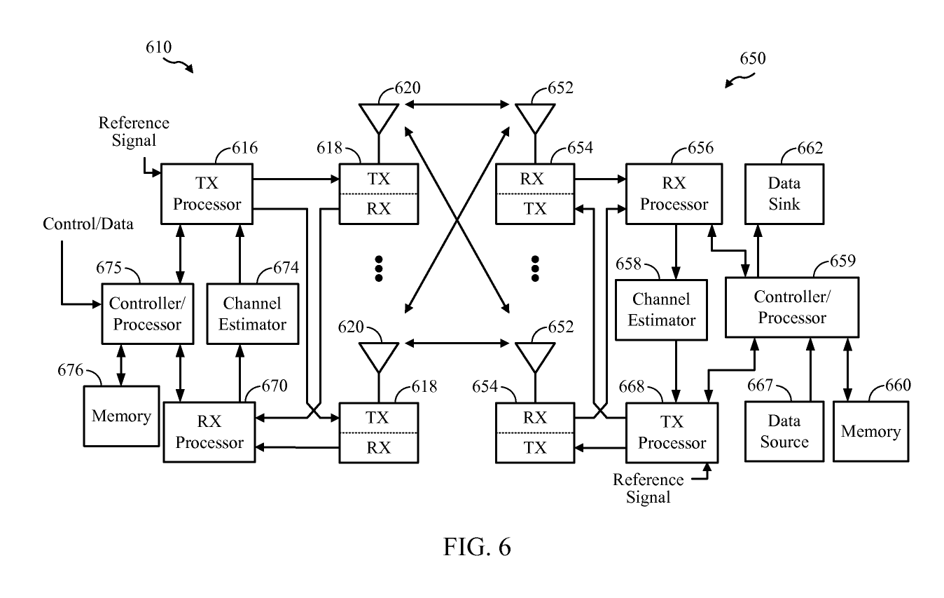

FIG. 6 is a block diagram of an eNodeB 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver processor 656. The receiver processor 656 implements various signal processing functions of the L1 layer. The receiver processor 656 performs spatial processing on the information to recover any spatial streams destined for the UE 650. If multiple spatial streams are destined for the UE 650, they may be combined by the receiver processor 656 into a single OFDM symbol stream. The receiver processor 656 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The uplink transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

### Time Division Long Term Evolution (TD-LTE) Frame Structure Modification

The spectrum available for Internet communication to aircraft by terrestrial air to ground (ATG) systems is limited for practical and economic reasons. Providing seamless communication with aircraft flying at high altitudes over a large area (such as the continental U.S.) involves spectrum that is available over the large area. That is, the spectrum assigned to the ATG system should be available nationwide. It has been problematic, however, to identify a portion of spectrum that is available nationwide, much less arranging to free up such a portion of spectrum that is allocated for other uses.

A large amount of spectrum is assigned to geostationary satellites for use in broadcast TV and two way fixed satellite service (FSS). In one aspect of the present disclosure, a high data rate aircraft to ground communications antenna system provides an aircraft with Internet service.

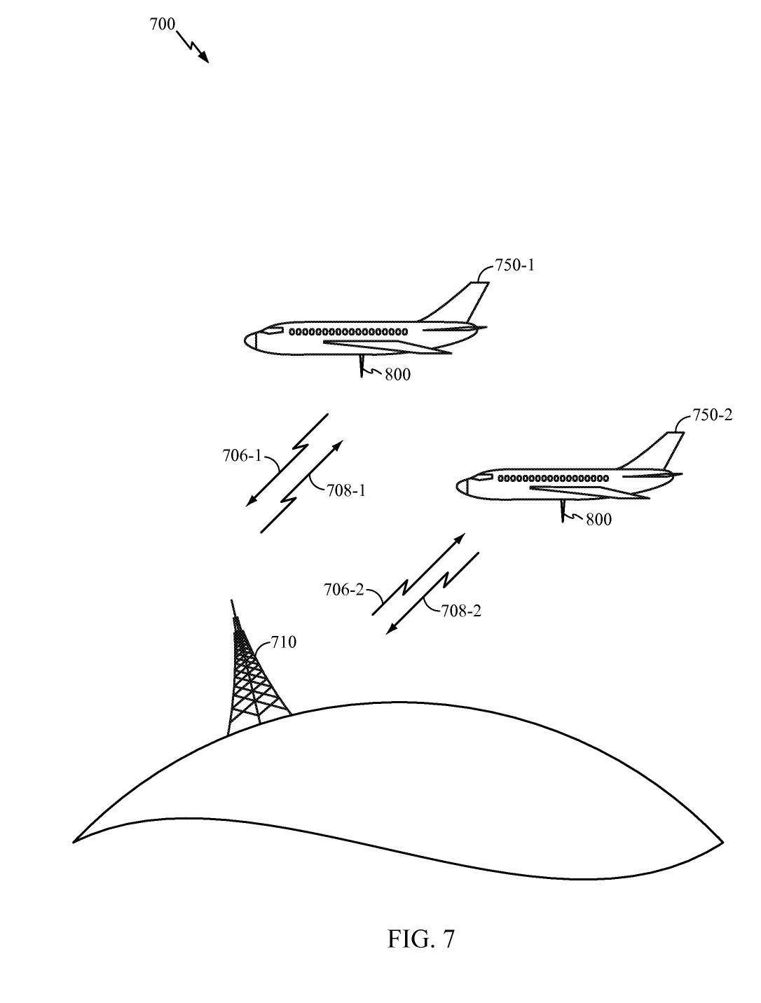

In particular, aspects of the present disclosure provide methods and apparatus for a next generation air to ground (Next-Gen AG) system. The Next-Gen AG system may include ground base stations (GBSs) in communication with aircraft transceivers (ATs) in airplanes that may use an uplink portion of spectrum assigned for satellite systems. A system 700 for Next-Gen AG communication according to an illustrative aspect of the present disclosure is shown in FIG. 7.

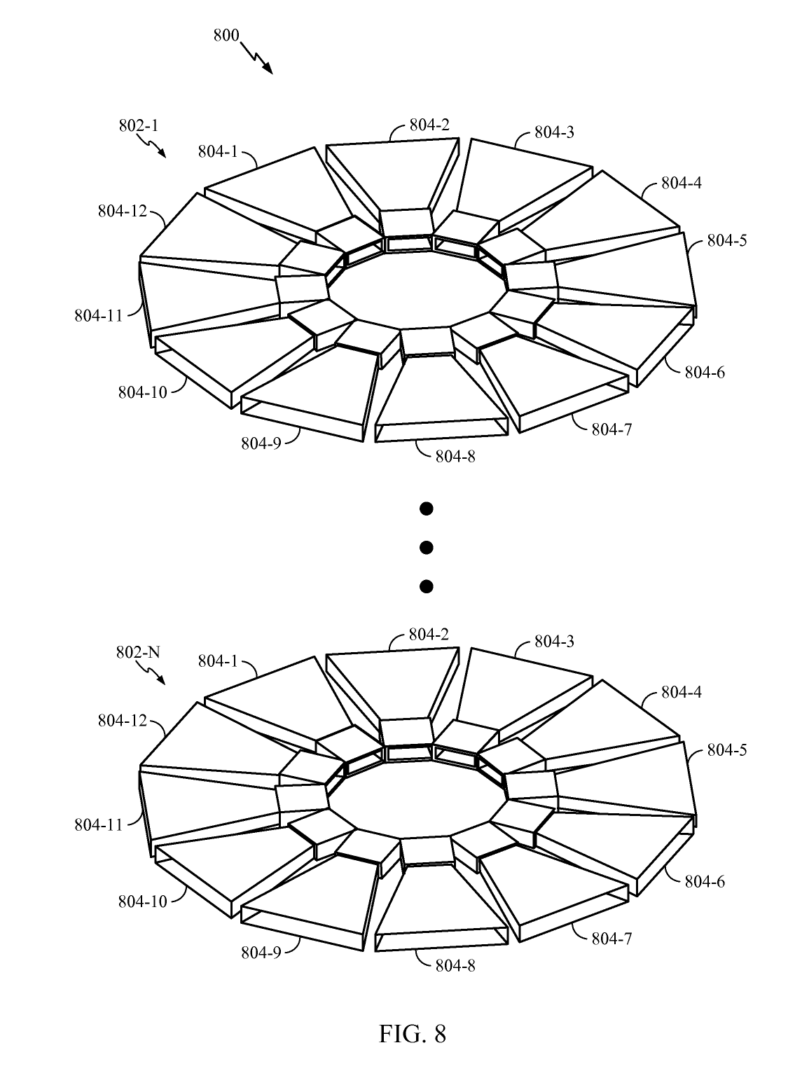

In this configuration, the Next-Gen AG system 700 includes a ground base station 710 that transmits and receives signals on a satellite uplink band using a forward link (FL) 708-1 and a reverse link (RL) 706-1. A first aircraft 750-1 includes an aircraft antenna 800 and aircraft transceiver (AT) 650 (FIG. 6) in communication with the ground base station 710. The aircraft transceiver (AT) 650 may also receive and transmit signals on the satellite uplink band using the forward link 708-1 and the return link 706-1. In this configuration, the aircraft antenna 800 may include a directional antenna, for example, as shown in FIG. 8.

FIG. 8 shows one example of an aircraft antenna 800 having aircraft antenna arrays 802 (802-1, . . . , 802-N) operating at, for example, 14 gigahertz (GHz). Representatively, the aircraft antenna array 802-1 has twelve horn antennas 804 (804-1, . . . , 804-12) each covering 30° sectors in azimuth with an aperture size of approximately 2.0 inches×0.45 inches, and having a gain of >10 dBi (dB isotropic). In one configuration, an overall diameter of the antenna array is roughly 8 inches. Although described with reference to an aircraft antenna array, any directional antenna may be provided according to the aspects of the present disclosure. While the described aspect of the present disclosure are provided with reference to aircraft, the present disclosure is not limited thereto. Aspect of the present disclosure may apply to any current or future airborne objects that communicate with a ground station.

In this configuration, the aircraft antenna 800 includes a multi-beam switchable array that is able to communicate with the ground base station 710 at any azimuth angle. As shown in FIG. 7, the aircraft antenna 800 is mounted below the fuselage with a small protrusion and aerodynamic profile to reduce or minimize wind drag. In one configuration, the antenna elevation coverage is from approximately 3° to 20° below horizon to provide, for example, the pointing directions for the antenna gain. The aircraft antenna 800 may include an array N of elements positioned such that each element directs a separate beam at different azimuth angles, each covering 360/N degrees, for example, as shown in FIG. 8.

Although FIG. 8 illustrates the aircraft antenna arrays 802 in a twelve-beam array configuration, it should be recognized that other configurations are possible while remaining within the scope of the present disclosure. In particular, one example configuration includes four-antenna arrays in a four-beam array configuration. In another configuration, a directional antenna may be provided as part of the Next-Gen AG system 700 while remaining within the scope of the present disclosure.

Referring again to FIG. 7, a second aircraft 750-2 includes a system having an aircraft antenna 800 that communicates with an aircraft transceiver (AT) 650, as shown in FIG. 6. The aircraft antenna 800 is in communication with the ground base station 710 and also receives and transmits signals on the satellite uplink band using a forward link 708-2 and a return link 706-2.

A Next-Gen AG system, for example, as shown in FIG. 7, may provide broadband connectivity to flying aircraft using an aircraft transceiver (AT) 650, as shown in FIG. 6. In this configuration, the aircraft transceiver may operate according to a time division long term evolution (TD-LTE) air interface. In a time division duplex (TDD) terminal (e.g., the AT 650), however, a timing-advanced uplink transmission should not overlap with reception of any preceding downlink.

For example, a TD-LTE air interface may operate according to an orthogonal uplink intra-cell multiple access scheme. In this example, transmissions from different UEs (e.g., AT 650) in a cell are time aligned at the receiver of the eNodeB (e.g., the ground base station 710) to maintain uplink multiple access orthogonality. In operation, a timing advance may be applied at the UE transmitter to provide time alignment of the uplink transmissions relative to the received downlink timing. Using a timing advance at the base station may counteract the various propagation delays between different UEs.

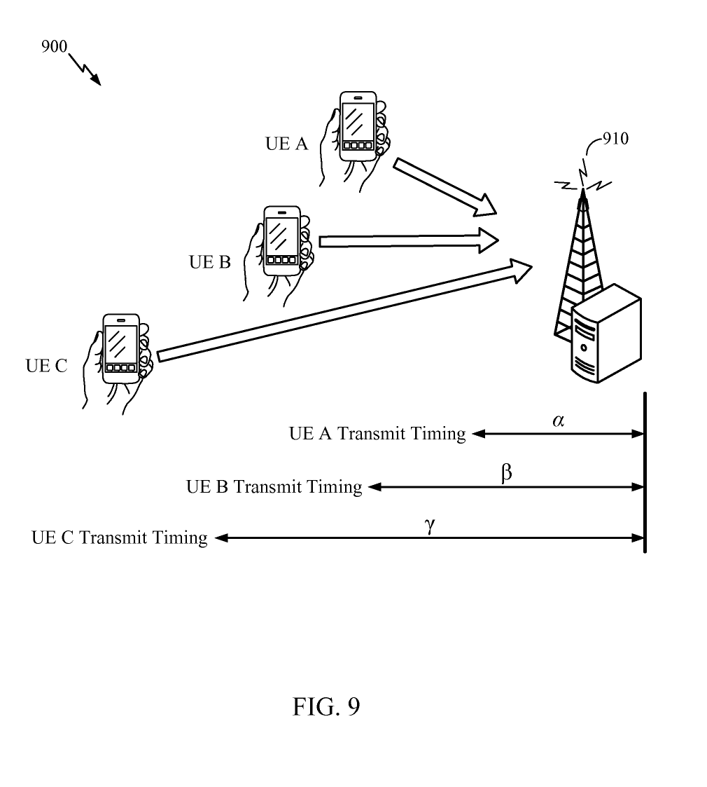

FIG. 9 is a block diagram 900 in which a UE A, a UE B and a UE C are positioned at different distances from a base station 910. The differing distances from the base station 910, however, result in varying propagation delays from the different UEs to the base station 910. In this example, the UE transmissions are orthogonal when they arrive at the base station and are made synchronous in the time domain by performing timing advance (TA) signaling at the base station. Generally, the application of the timing advance at the base station synchronizes the UE transmissions within a fraction of the CP (cyclic prefix) length. A timing advance command may be sent as a medium access control (MAC) element with a 0.52 microsecond timing resolution and from 0 up to a maximum of 0.67 milliseconds in a baseline TD-LTE configuration. In this example, the UE A receives a timing advance (α), UE B receives a timing advance (β) and UE C receives a timing advance (γ) to enable time alignment at the receiver of the base station 910.

In TD-LTE, switching between transmit/receive functions occurs from downlink to uplink (UE switching from reception to transmission) and from uplink to downlink (eNodeB (base station) switching from reception to transmission). To preserve the orthogonality of the LTE uplink, propagation delays between an eNodeB and the UEs are compensated by a timing advance. For a time division duplex (TDD) system, the timing-advanced uplink transmission should not overlap with reception of any preceding downlink.

A TD-LTE air interface may prevent overlap between downlink and uplink communication by specifying a transmission gap (e.g., a guard period (GP)) between the downlink and uplink communications. The guard period between reception (downlink) and transmission (uplink) may be specified to accommodate a greatest possible timing advance and any switching delay. The timing advance of the TD-LTE air interface is a function of the round-trip propagation delay. In addition, the total guard time for an uplink-downlink cycle of a TD-LTE air interface may be longer than the worst round-trip propagation delay supported by a cell.

FIG. 10 is a timing diagram 1000 in which a guard period (T_{GP}) 1012 between a downlink communication 1008-1 and an uplink communication 1006-1 of an eNodeB is selected to prevent overlap between a downlink communication 1008-2 and an uplink communication 1006-2 of a UE 1050. To prevent the overlap, the guard period (T_{GP}) should exceed both a round-trip propagation delay (2T_{P}) and a receive-to-transmit switching delay (T_{UE-Rx-Tx}) 1016 at the UE 1050, where T_{P} denotes the one-way propagation delay. For example, the guard period (T_{GP}) may be computed according the following equation:

T_{GP}>2T_{P}+T_{UE-Rx-Tx} (1)

The 3GPP LTE specification, however, is limited to a guard period duration of approximately 0.72 milliseconds. This guard period duration presumes a maximum one-hundred (100) kilometer cell radius. In a Next-Gen AG system, however, a larger cell size (e.g., a cell radius of two-hundred fifty (250) to three hundred fifty (350) kilometers) may be specified.

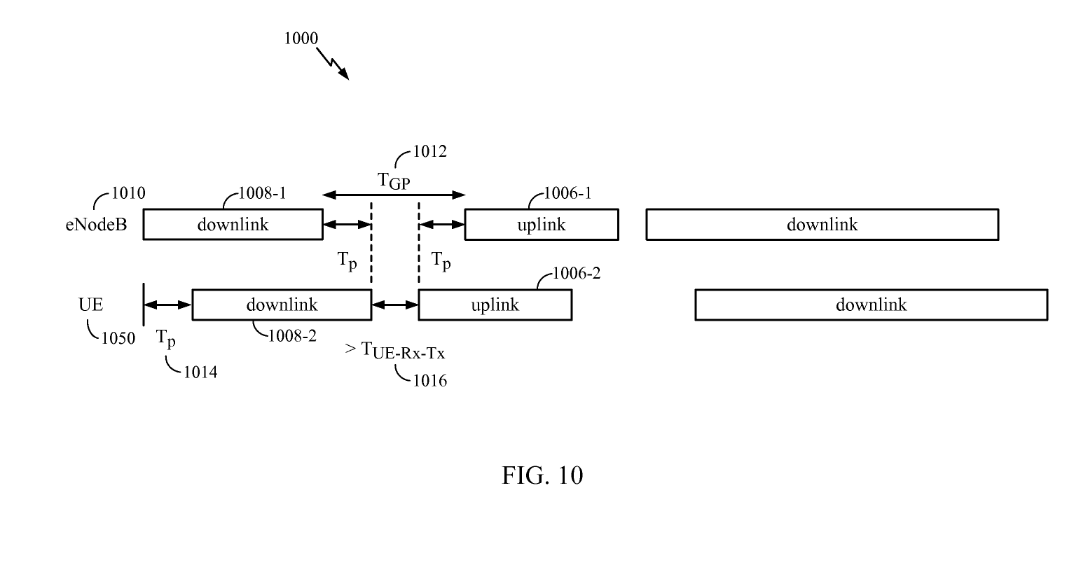

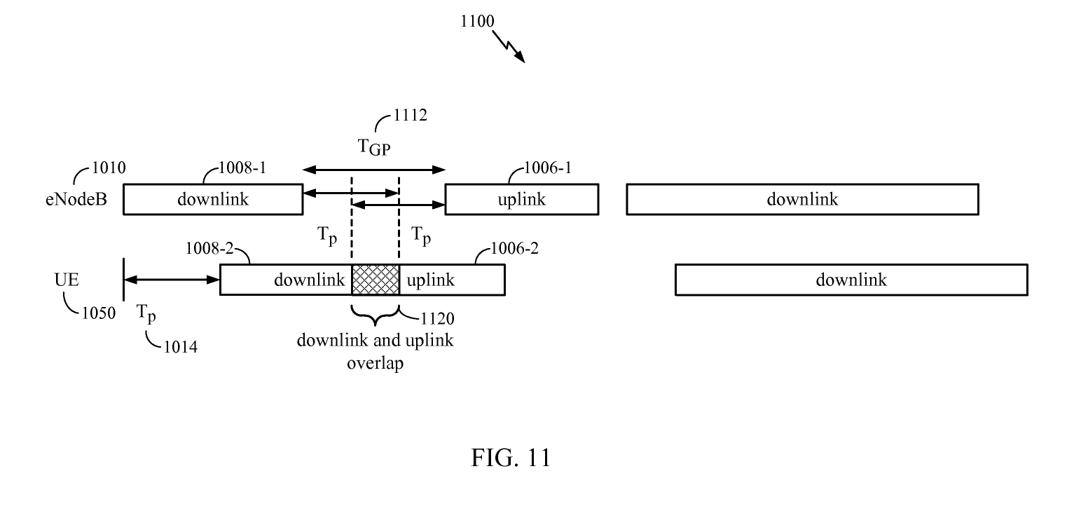

FIG. 11 is a timing diagram 1100 in which a duration of the guard period (T_{GP}) 1112 between a downlink communication 1008-1 and an uplink communication 1006-1 of an eNodeB 1010 is insufficient, resulting in an overlap 1120 between a downlink communication 1008-2 and an uplink communication 1006-2 of the UE 1050. As a result, using the 3GPP defined TDD frame structures leads to uplink-downlink overlap and significant signal degradation and data loss within a Next-Gen AG system.

In one aspect of the present disclosure, the frame structure used by an air interface of a Next-Gen AG system structure is modified. In one configuration, a TD-LTE frame structure with a two (2) millisecond special subframe is specified to support a cell radius on the order of two-hundred (200) to two-hundred fifty (250) kilometers. In another configuration, a TD-LTE frame structure with a three (3) millisecond special subframe is specified to support a cell radius on the order of three-hundred (300) to three-hundred fifty (350) kilometers. In a further configuration, a nested frame structure provides co-existence between different uplink-downlink subframe configurations. In one aspect of the present disclosure, air cells are categorized into multiple zones based on the distance to a base station (e.g., an eNodeB 610). In this aspect of the disclosure, different uplink/downlink subframe configurations corresponding to different round-trip propagation delays are used to accommodate communication with each of the multiple zones.

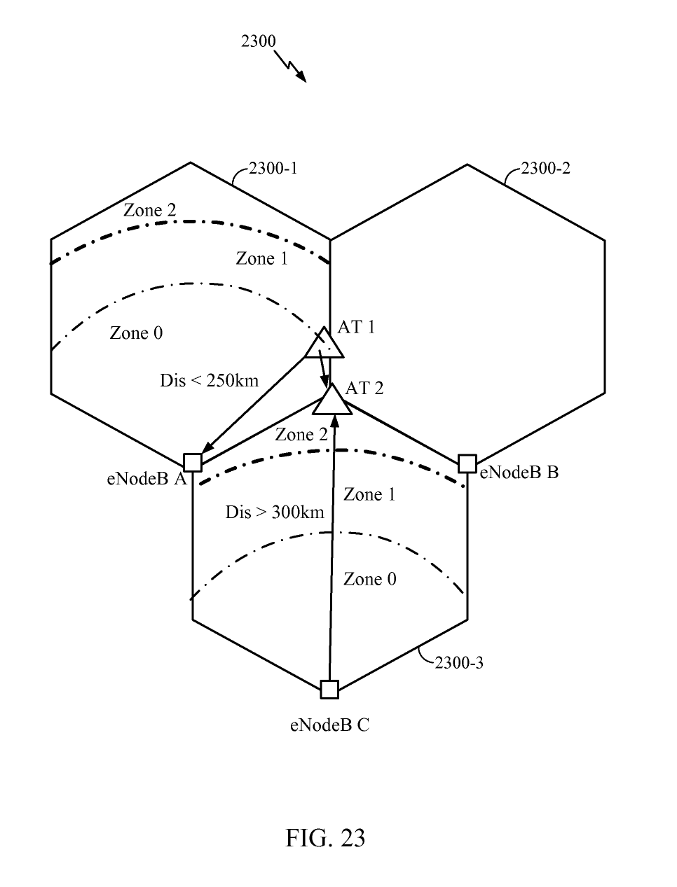

The nested frame structure enables dynamic variation as an airborne object moves from one zone to another. For example, the nested frame structure enables dynamic switching between various special subframes lengths in each zone. This dynamic switching may be achieved with or without a break in the call. When it is achieved without breaking the call, the nested frame structure becomes a dynamic frame structure. In one configuration, the nested frame structure dynamically varies between a non-extended special subframe, a first extended special subframe and a second extended special subframe as the UE moves between difference zones of an air cell (e.g., Zone 0, Zone 1 and Zone 2 of FIG. 23).

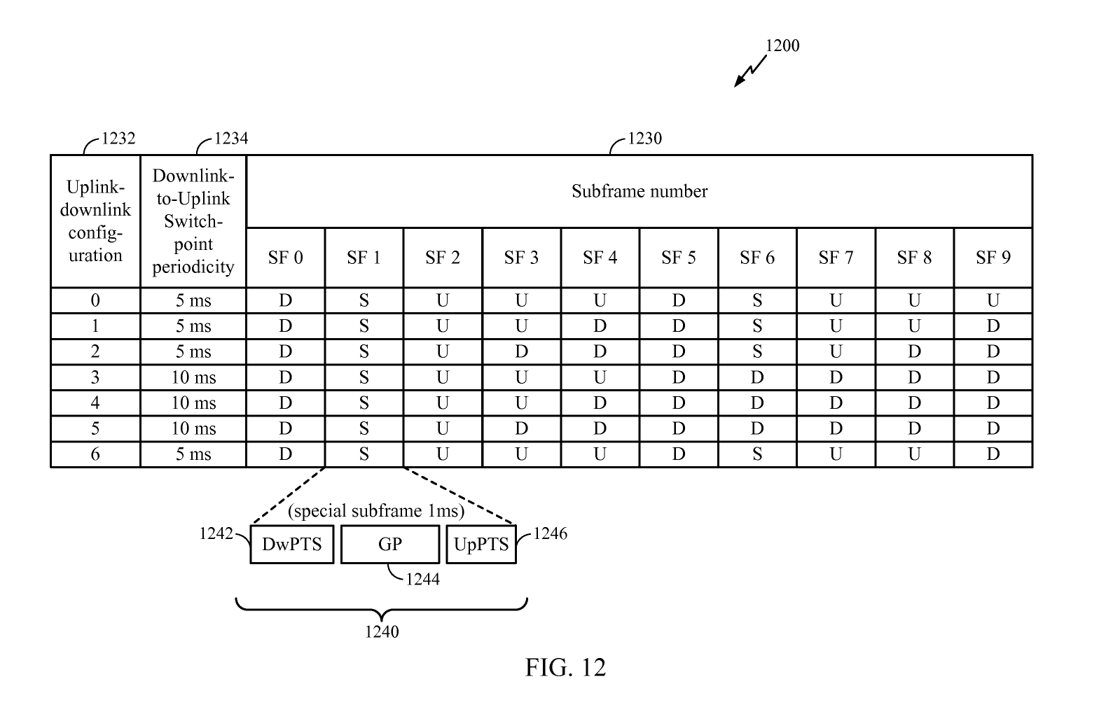

FIG. 12 is a block diagram illustrating a conventional TD-LTE radio frame structure 1200. Representatively, the conventional TD-LTE radio frame structure 1200 includes a subframe number 1230, an uplink-downlink configuration column 1232 and a downlink-to-uplink switch-point periodicity column 1234. In this example, the TD-LTE radio frame structure spans ten (10) milliseconds and consists of ten (10) one (1) millisecond subframes (SF 0, . . . , SF 9). The various subframes may be configured as a downlink (D) subframe, an uplink (U) subframe or a special (S) subframe. In this example, SF 1 is configured as a special subframe in each of the seven (0, . . . , 6) uplink-downlink configurations; SF 6 is configured as a special subframe in uplink-downlink configurations 0, 1, 2 and 6.

The special subframe 1240 serves as a switching point between downlink and uplink communications. The special subframe 1240 includes a downlink pilot time slot (DwPTS) portion 1242, a guard period (GP) portion 1244 and an uplink pilot time slot (UpPTS) portion 1246. In operation, the DwPTS portion 1242 of the special subframe 1240 may be treated as a regular but shortened downlink subframe. The DwPTS portion 1242 usually contains a reference signal (RS), control information and a primary synchronization signal (PSS). The DwPTS portion may also carry data transmissions. The UpPTS portion 1246 of the special subframe 1240 may be used for either a sounding reference signal (e.g., a one (1) symbol length) or a special (random access channel (RACH) for a small cell size (e.g., a two (2) symbol length).

As shown in FIG. 12, the GP portion 1244 of the special subframe 1240 provides a switching point between downlink and uplink communications. A length of the GP portion 1244 of the special subframe 1240 is one of the factors in determining the maximum supportable cell size. In this example a maximum length of the GP portion 1244 is:

MaxGPLength=10 OFDM symbols+10 CPs=0.714 milliseconds (2)

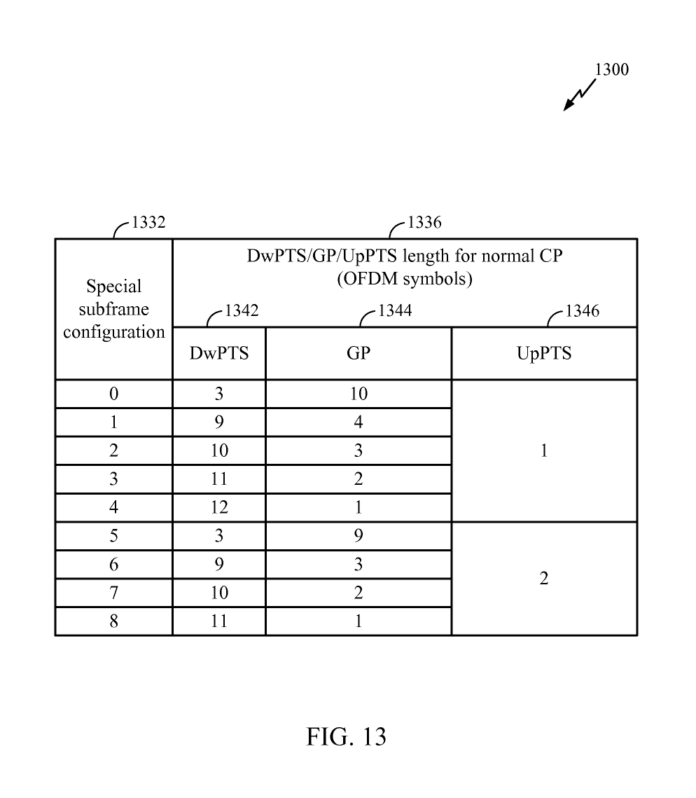

FIG. 13 is a table 1300 illustrating special subframe component lengths according to the various special subframe configurations based on a normal cyclic prefix (CP). The table 1300 includes a special subframe configuration column 1332, a DwPTS column 1342, a GP column 1344 and an UpPTS column 1346 within a component length column 1336. In this example, the component lengths are indicated in units of orthogonal frequency division multiplexing (OFDM) symbols.

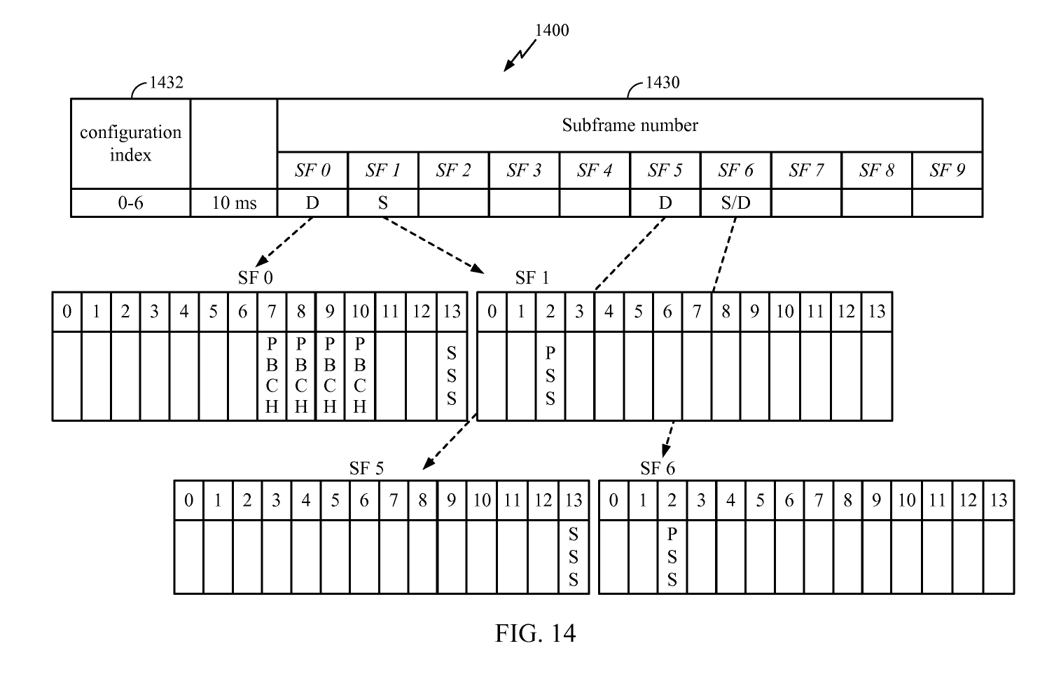

FIG. 14 illustrates the time-domain resource allocation of synchronization and broadcast channels within the subframes of a TD-LTE radio frame structure 1400 based on a configuration index 1432 and a subframe number 1430. In this example, a primary synchronization signal (PSS) is allocated within the third OFDM symbol of subframe 1 and subframe 6 (e.g., every five (5) milliseconds of either a downlink subframe or a DwPTS portion of a special subframe). A secondary synchronization signal (SSS) is allocated within the last OFDM symbol of subframe 0 and subframe 5 (e.g., every five (5) milliseconds of a downlink subframe). A physical broadcast channel (PBCH) is allocated within OFDM symbols 7-10 of subframe 0 (e.g., every ten (10) milliseconds). A system information block of type 1 (SIB 1) is allocated within subframe 5 (e.g., an even radio frame).

In one aspect of the present disclosure, the radio frame structure used by an air interface of a Next-Gen AG system structure is modified to accommodate a larger cell radius. As noted, a TD-LTE air interface may prevent overlap between uplink and downlink communication by specifying a transmission gap (e.g., a guard period (GP)) between the downlink and uplink communications. The 3GPP LTE specification, however, is limited to guard period durations on the order of 0.714 milliseconds (see equation (2)). This guard period duration presumes a maximum one-hundred (100) kilometer cell radius. In a Next-Gen AG system, however, a larger cell size (e.g., a cell radius of two-hundred fifty (250) to three hundred fifty (350) kilometers) is specified.

In one aspect of the present disclosure, a special subframe is redesigned to enable downlink to uplink switching with a large round trip delay (RTD). As noted above in FIG. 10, overlap is prevented by specifying a guard period (T_{GP}) that exceeds a round-trip propagation delay (2T_{P}) and a receive-to-transmit switching delay (T_{UE-Rx-Tx}) 1016 at the UE 1050, where T_{P} denotes the one-way propagation delay. The guard period (T_{GP}) may be computed according to equation (1). For example, assuming an expanded cell radius of two-hundred fifty (250) kilometers (km), the round trip propagation delay when an aircraft is at a cell edge, is given by:

2Tp(250 km)=(2×250 km)/speed-of-light≈1.67 milliseconds (3)

Assuming an expanded cell radius of three-hundred fifty (350) kilometers (km), the round trip propagation delay when an aircraft is at a cell edge, is given by:

2Tp(350 km)=(2×350 km)/speed-of-light≈2.33 milliseconds (4)

The 3GPP LTE specification, however, is limited to a smaller guard period duration (e.g., 0.714 milliseconds) to support a maximum one-hundred (100) kilometer cell radius. Based on equation (1), for a two-hundred fifty (250) kilometer cell radius, the guard period is computed as follows:

T_{GP}>1.67 milliseconds+T_{UE-Rx-Tx} (5)

For a three-hundred fifty (350) kilometer cell radius, the guard period is computed as follows:

T_{GP}>2.33 milliseconds+T_{UE-Rx-Tx} (6)

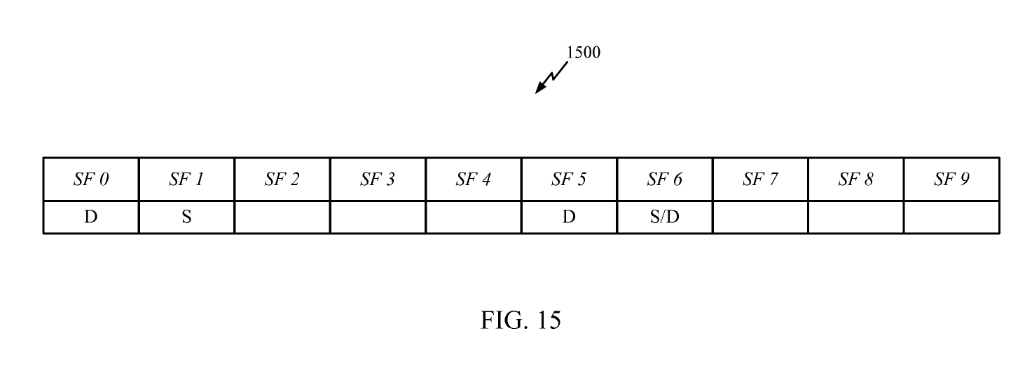

FIG. 15 is a block diagram illustrating a modified radio frame structure 1500 according to one aspect of the present disclosure. This configuration of the modified radio frame structure 1500 maintains the 3GPP synchronization/broadcast channel structure shown in FIG. 14. In this configuration, subframes 0, 1, 5 and 6 are either downlink or special subframes to allow primary synchronization signal (PSS), secondary synchronization signal (SSS), broadcast control channel (BCCH), dynamic broadcast channel (D-BCH) and system information block of type 1 (SIB1) transmissions. Maintaining the 3GPP synchronization/broadcast channel structure shown in FIG. 14 avoids complex hardware changes.

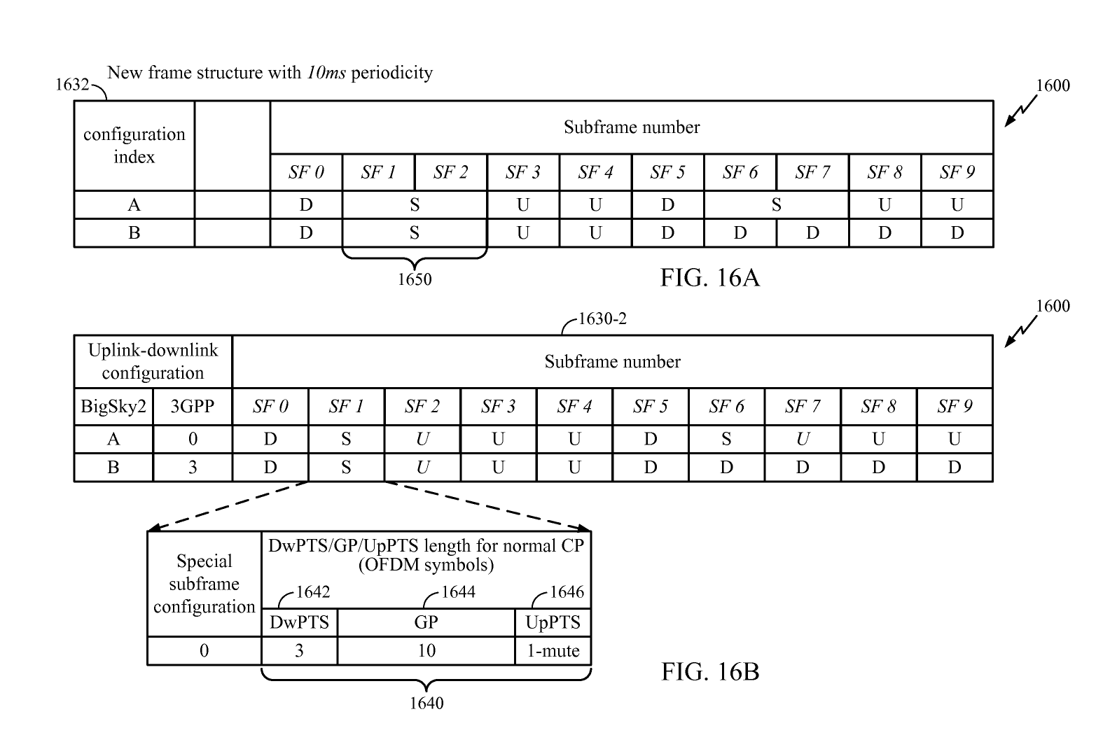

FIG. 16A is a block diagram illustrating one configuration of a TD-LTE radio frame structure with a first extended special subframe (e.g., two (2) milliseconds) to support a first extended cell radius on the order of two-hundred fifty (250) kilometers. The frame structure 1600 has a ten (10) millisecond periodicity that includes an extended special subframe 1650 that extends over subframe 1 and subframe 2. This frame structure 1600 supports Next-Gen AG system configurations A and B, as noted by the configuration index 1632. In this configuration, the Next-Gen AG system configuration A is based on uplink-downlink configuration zero (0), as shown in FIG. 12. In addition, the Next-Gen AG system configuration B is based on uplink-downlink configuration three (3), as shown in FIG. 12.

FIG. 16B further illustrates a modified special subframe 1640 to enable formation of the extended special subframe 1650 shown in FIG. 16A. The modified special subframe 1640 includes a downlink pilot time slot (DwPTS) portion 1642 and a guard period (GP) portion 1644. An uplink pilot time slot (UpPTS) portion 1646 and the adjacent uplink subframe (e.g., SF 2 and/or SF 7) are omitted (muted) to extend the guard period (GP) portion 1644 to form the extended special subframe 1650 (FIG. 16A). For example, the guard period (GP) portion 1644 may be combined with a GP portion of a muted, adjacent uplink subframe (e.g., SF 2, SF 7 and SF 12) to provide a twenty five (25) OFDM symbol length (e.g. 1.785 ms), depending on whether a normal or extended cyclic prefix is used. In this configuration, the DwPTS portion 1642 of the modified special subframe 1640 is treated as a regular, but shortened downlink subframe. For example, the DwPTS portion 1642 may have a three (3) OFDM symbol length, used to transmit a reference signal (RS), control information, a primary synchronization signal (PSS), and the like.

In this configuration, special subframe configuration zero (0) is applied while muting the UpPTS portion 1646. For example, the UpPTS portion 1646 may be muted by not scheduling any sounding reference signals. In Next Gen AG system configuration B, uplink subframe 2, adjacent to special subframe 1 is muted to provide the extended special subframe 1650 as a two (2) millisecond extended special subframe. In this example, the uplink subframe 2 is muted by not scheduling any uplink data transmissions during uplink subframe 2. Muting the uplink subframe 2 may also involve moving any acknowledgement (ACK)/negative acknowledgement (NACK) feedback to a next suitable subframe. Also, any channel quality information (CQI), precoding matrix indicator, and/or rank indicator information is not reported during the uplink subframe 2. In addition, no sounding reference signal (SRS), scheduling request (SR), and/or physical random access channel (PRACH) transmission are performed during the uplink subframe 2. In Next-Gen AG system configuration A, both uplink subframe 2, adjacent to special subframe 1, and uplink subframe 7, adjacent to special subframe 6 are muted to provide the extended special subframe 1650.

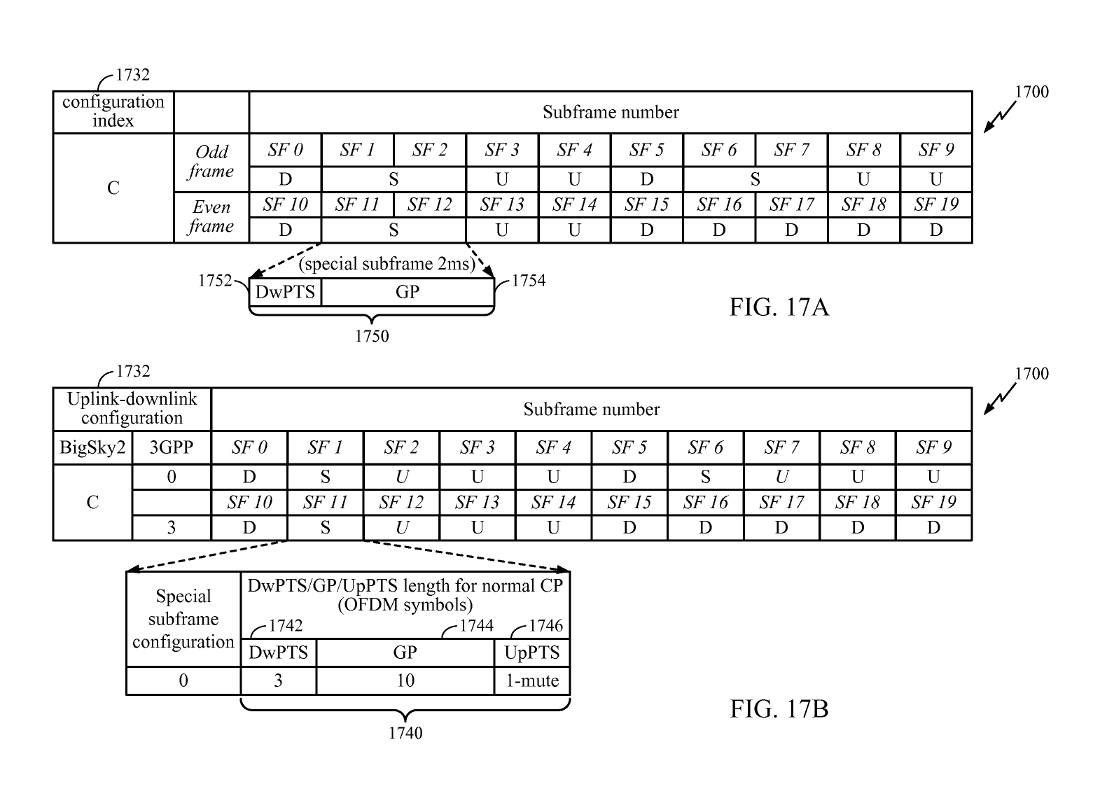

FIG. 17A illustrates another configuration of a TD-LTE frame structure 1700 with a first extended special subframe (e.g., two (2) milliseconds) also specified to support the first extended cell radius (e.g., two-hundred (200) to two-hundred fifty (250) kilometers). The TD-LTE frame structure 1700 has a twenty (20) millisecond periodicity with an extended special subframe 1750 that extends over special subframe 1 and uplink subframe 2. In this configuration, the extended special subframe 1750 includes a downlink pilot time slot (DwPTS) portion 1752 and an extended guard period (GP) portion 1754. This TD-LTE frame structure 1700 supports Next-Gen AG system configuration C, as noted by the configuration index 1732. In this configuration, the Next-Gen AG system configuration C dynamically switches between uplink-downlink configuration zero (0), and uplink-downlink configuration three (3), as shown in

FIG. 12. For example, even subframes may use uplink-downlink configuration zero (0) and odd subframes may use uplink-downlink configuration three (3).

FIG. 17B further illustrates a modified special subframe 1740 to enable formation of the extended special subframe 1750, shown in FIG. 17A. The modified special subframe 1740 includes a downlink pilot time slot (DwPTS) portion 1742 and a guard period (GP) portion 1744. An uplink pilot time slot (UpPTS) portion 1746 and an adjacent uplink subframe (e.g., SF 2, SF 7 and/or SF 12) are omitted (e.g., muted) to extend the guard period (GP) portion 1744 to form the extended special subframe 1750 (FIG. 17A). In this configuration, the DwPTS portion 1742 of the modified special subframe 1740 is treated as a regular, but shortened downlink subframe. For example, the DwPTS portion 1742 may have a three (3) OFDM symbol length to transmit a reference signal (RS), control information, a primary synchronization signal (PSS), and the like. In this example, the guard period (GP) portion 1744 may be combined with a GP portion of a muted, adjacent uplink subframe (e.g., SF 2, SF 7 and SF 12) to provide a twenty five (25) OFDM symbol length (e.g. 1.785 ms). In one configuration, a maximum timing advance of approximately 1.67 milliseconds is applied at the base station (e.g., an eNodeB 610) to synchronize communication.

In this configuration, special subframe configuration zero (0) is also applied while muting the UpPTS portion 1746. The UpPTS portion 1746 may be muted by not scheduling any sounding reference signals. For example, the uplink subframe 2, adjacent to special subframe 1 is muted to provide the extended special subframe 1750 as a two (2) millisecond extended special subframe. The uplink subframe 2 may be muted by not scheduling any uplink data transmissions during uplink subframe 2. Muting the uplink subframe 2 may also involve moving any acknowledgement (ACK)/negative acknowledgement (NACK) feedback to a next suitable subframe. Also, any channel quality information (CQI), precoding matrix indicator, and/or rank indicator information is not reported during uplink subframe 2. In addition, no sounding reference signal (SRS), scheduling request (SR), and/or physical random access channel (PRACH) transmission are performed during uplink subframe 2.

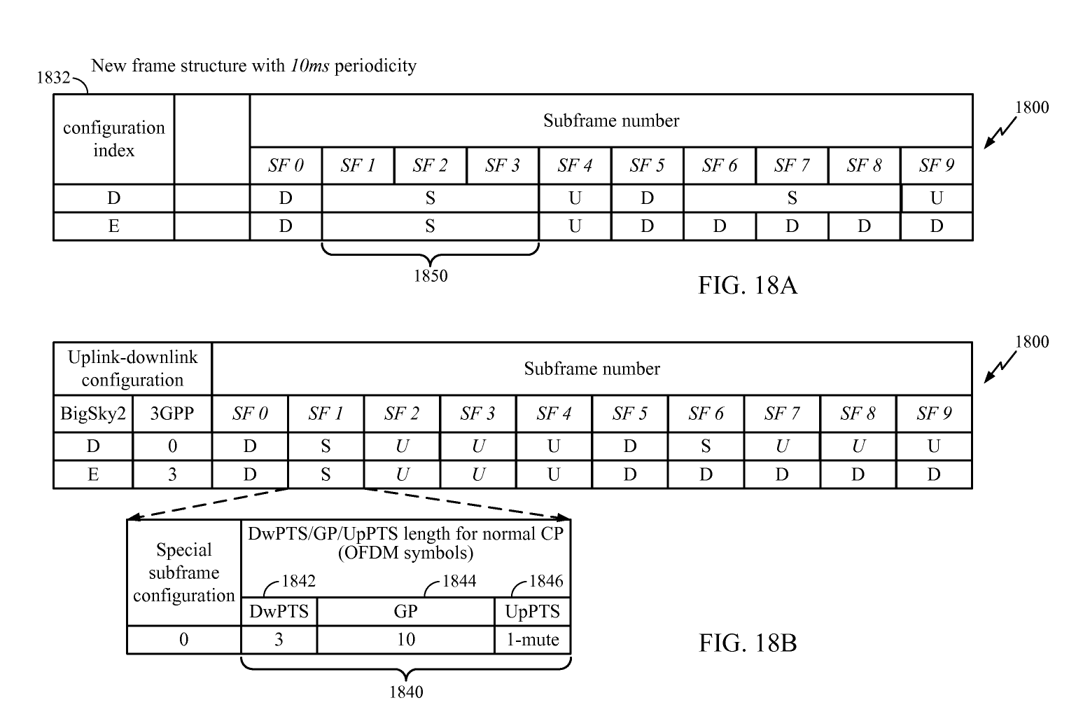

FIG. 18A illustrates another configuration of a TD-LTE frame structure 1800 with a second extended special subframe (e.g., three (3) milliseconds) specified to support a second extended cell radius on the order of three-hundred (300) to three-hundred fifty (350) kilometers. The TD-LTE frame structure 1800 has a ten (10) millisecond periodicity with an extended special subframe 1850 that extends over subframe 1, subframe 2 and subframe 3. In this configuration, the extended special subframe 1850 includes a downlink pilot time slot (DwPTS) portion 1852 and an extended guard period (GP) portion 1854. This TD-LTE frame structure 1800 supports Next-Gen AG system configurations D and E, as noted by the configuration index 1832. In this configuration, the Next-Gen AG system configuration D is based on uplink-downlink configuration zero (0), as shown in FIG. 12. In addition, the Next-Gen AG system configuration E is based on uplink-downlink configuration three (3), as shown in FIG. 12.

FIG. 18B illustrates a modified special subframe 1840 to enable formation of the extended special subframe 1850, shown in FIG. 18A. The modified special subframe 1840 also includes a downlink pilot time slot (DwPTS) portion 1842 and a guard period (GP) portion 1844. An uplink pilot time slot (UpPTS) portion 1846 and the two contiguous, adjacent uplink subframes (e.g., SF 2 and SF 3, SF 7 and SF 8) are omitted (e.g., muted) to extend the guard period (GP) portion 1844 to form the extended special subframe 1850 (FIG. 18A). For example, the guard period (GP) portion 1844 may be combined with a GP portion of a muted, adjacent uplink subframe (e.g., SF 2 and SF 3, SF 7 and SF 8) to provide a thirty nine (39) OFDM symbol length (e.g. 2.72 milliseconds). In this configuration, the DwPTS portion 1842 of the modified special subframe 1840 is also treated as a regular, but shortened downlink subframe. For example, the DwPTS portion 1842 may have a three (3) OFDM symbol length to transmit a reference signal (RS), control information, a primary synchronization signal (PSS), and the like.

In this configuration, special subframe configuration zero (0) is also applied while muting the UpPTS portion 1846. In this example, the UpPTS portion 1846 is muted by not scheduling any sounding reference signals. Representatively, uplink subframe 2 and uplink subframe 3 adjacent to special subframe 1 are muted to provide the extended special subframe 1850 as a three (3) millisecond extended special subframe. In this example, uplink subframe 2 and uplink subframe 3 are muted by not scheduling any uplink data transmissions during uplink subframes 2 and 3. Muting uplink subframes 2 and 3 may also involve moving any acknowledgement (ACK)/negative acknowledgement (NACK) feedback to a next suitable subframe. Also, any channel quality information (CQI), precoding matrix indicator, and/or rank indicator information is not reported during uplink subframes 2 and 3. In addition, no sounding reference signal (SRS), scheduling request (SR), and/or physical random access channel (PRACH) transmission are performed during the uplink subframes 2 and 3.

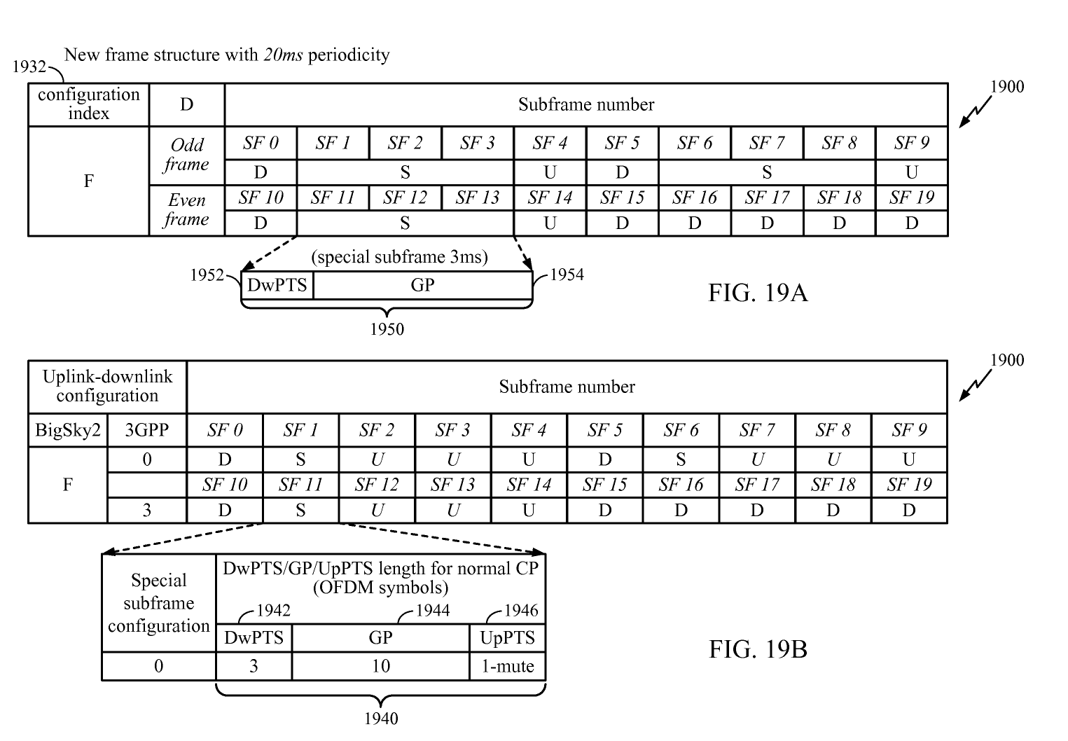

FIG. 19A illustrates another configuration of a TD-LTE frame structure 1900 with a three (3) millisecond special subframe specified to support the second extended cell radius (e.g., three-hundred fifty (350) to four-hundred (400) kilometers). The TD-LTE frame structure 1900 has a twenty (20) millisecond periodicity with an extended special subframe 1950 that extends over subframes 1 to 3, 6 to 8 and 11 to 13. In this configuration, the extended special subframe 1950 includes a downlink pilot time slot (DwPTS) portion 1952 and an extended guard period (GP) portion 1954. This TD-LTE frame structure 1900 supports Next-Gen AG system configuration F, as noted by the configuration index 1932. In this configuration, the Next-Gen AG system configuration F dynamically switches between uplink-downlink configuration zero (0), and uplink-downlink configuration three (3), as shown in FIG. 12. For example, even subframes may use uplink-downlink configuration zero (0) and odd subframes may use uplink-downlink configuration three (3).

FIG. 19B illustrates a modified special subframe 1940 to enable formation of the extended special subframe 1950, shown in FIG. 19A. The modified special subframe 1940 includes a downlink pilot time slot (DwPTS) portion 1942 and a guard period (GP) portion 1944. An uplink pilot time slot (UpPTS) portion 1946 and the two contiguous, adjacent uplink subframes (e.g., SF 2 and SF 3, SF 7 and SF 8, SF 12 and SF 13) are omitted (e.g., muted) to extend the guard period (GP) portion 1944 to form the extended special subframe 1950 (FIG. 19A). In this configuration, the DwPTS portion 1942 of the modified special subframe 1940 is treated as a regular, but shortened downlink subframe. For example, the DwPTS portion 1942 may have a three (3) OFDM symbol length, used to transmit a reference signal (RS), control information, a primary synchronization signal (PSS), and the like. In this example, the guard period (GP) portion 1944 may be combined with a GP portion of a muted, adjacent uplink subframe (e.g., SF 2 and SF 3, SF 7 and SF 8, SF 12 and SF 13) to provide a thirty nine (39) OFDM symbol length (e.g. 2.72 milliseconds). In one configuration, a maximum timing advance of approximately 2.66 milliseconds is applied at the base station (e.g., an eNodeB 610) to synchronize communication.

In this configuration, special subframe configuration zero (0) is also applied while muting the UpPTS portion 1946. The UpPTS portion 1946 may be muted by not scheduling any sounding reference signals. For example, uplink subframes 2 and 3 adjacent to special subframe 1 are muted to provide the extended special subframe 1950 as a three (3) millisecond extended special subframe. In addition, uplink subframes 7 and 8 as well as uplink subframes 12 and 13 are muted. Uplink subframe 2 and 3, 7 and 8, and 12 and 13 may be muted by not scheduling any uplink data transmissions during these uplink subframes. Muting these uplink subframes may also involve moving any acknowledgement (ACK)/negative acknowledgement (NACK) feedback to a next suitable subframe. Also, any channel quality information (CQI), precoding matrix indicator, and/or rank indicator information is not reported during these uplink subframes. In addition, no sounding reference signal (SRS), scheduling request (SR), and/or physical random access channel (PRACH) transmission are performed during these uplink subframes.

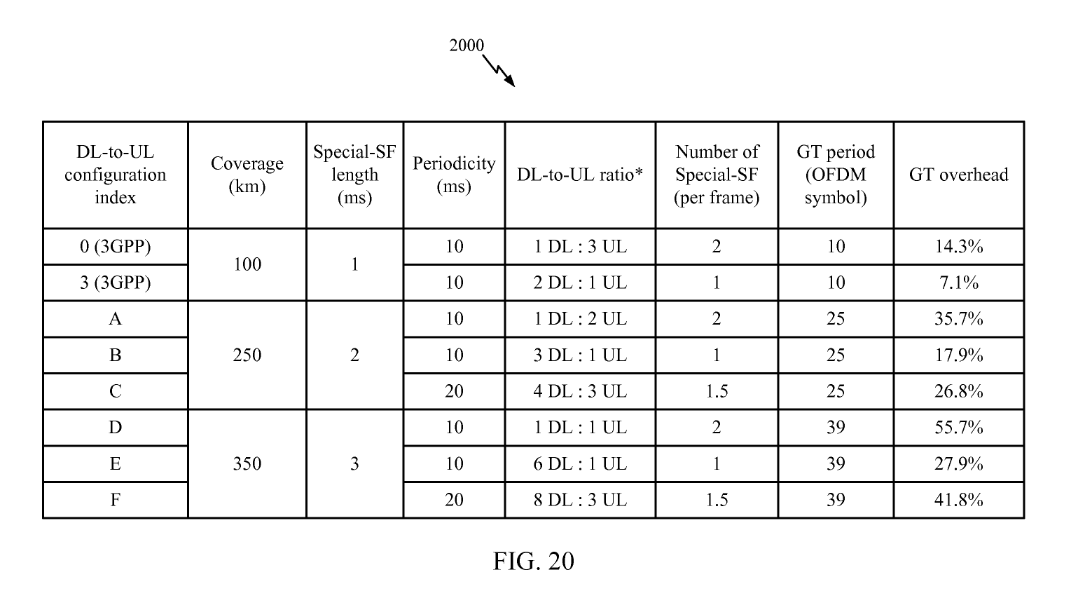

FIG. 20 is a table 2000 of the guard time overhead associated with the Next-Gen AG system configurations for supporting the first extended cell radius and the second extend cell radius as compared to a conventional (non-extended) cell radius. As noted above, the 3GPP LTE specification is limited to a guard time duration of approximately 0.72 milliseconds (e.g., 10 OFDM symbols). This guard period duration presumes a maximum one-hundred (100) kilometer cell radius, referred to herein as a non-extended cell radius. In a Next-Gen AG system, however, extended cell radii (e.g., a cell radius of two-hundred fifty (250) to three hundred fifty (350) kilometers) are specified. A guard time for a first extended cell radius (e.g., two-hundred fifty (250) kilometers) is approximately 1.78 milliseconds (e.g., twenty five (25) OFDM symbols). A guard time for a second extended cell radius (e.g., three-hundred fifty (350) kilometers) is approximately 2.72 milliseconds (e.g., thirty nine (39) OFDM symbols).

The table 2000 illustrates that supporting extended cell radii results in reduced system throughput as noted by the guard time (GT) overhead column. The system throughput loss due to the guard time overhead is in proportion to the coverage range (1:2.5:3.5). Supporting the extended cell radii involves a tradeoff between system throughput, uplink/downlink fairness (see DL-to-UL ratio column) and implementation complexity. The table 2000 illustrates that the Next-Gen AG system configurations B and F involve less guard time overhead, but with an unbalanced ratio of downlink/uplink flows. In addition, complexity varies between implementing an extended special subframe with a ten (10) millisecond periodicity and an extended special subframe with a twenty (20) millisecond periodicity. It should be noted that the DL-to-UL ratio column of the table 2000 does not include DwPTS in the special sub frame.

In a further configuration, a nested frame structure provides co-existence between different uplink-downlink subframe configurations. In one aspect of the present disclosure, air cells may be categorized into multiple zones based on the distance to a base station (e.g., an eNodeB 610). In this aspect of the disclosure, different uplink/downlink subframe configurations corresponding to different round-trip propagation delays may be used to accommodate communication with each of the multiple zones.

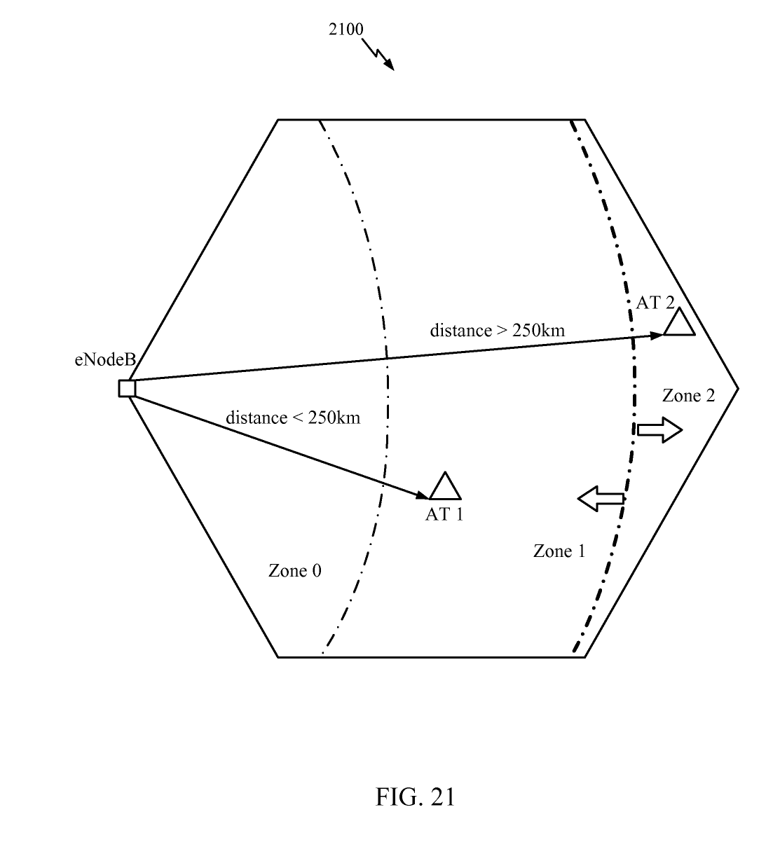

FIG. 21 illustrates categorization of an air cell 2100 into multiple zones to support extended cell radii according to one aspect of the present disclosure. In this configuration, the air cell 2100 includes an non-extended zone (Zone 0) for aircraft transceivers (ATs) that are less than eighty (80) to one-hundred (100) kilometers from a base station (e.g., eNodeB). The air cell 2100 also includes a first extended zone (Zone 1) for aircraft transceivers (ATs) that are less than two-hundred (200) to two-hundred fifty (250) kilometers from a base station (e.g., eNodeB). The air cell 2100 further includes a second extended zone (Zone 2) for aircraft transceivers (ATs) that are greater than two-hundred (200) to two-hundred fifty (250) kilometers from a base station (e.g., eNodeB). In this example, a first aircraft transceiver AT 1 is in the first zone (Zone 1) and a second aircraft transceiver AT 2 is in the second zone (Zone 2). In another scenario, the Airborne Object could be within Zone 0, and thus does not apply extended special subframe at all. In this scenario, the nested frame structure could dynamically change from applying an extended special subframe to applying a non-extended special subframe in co-ordination with a base station.

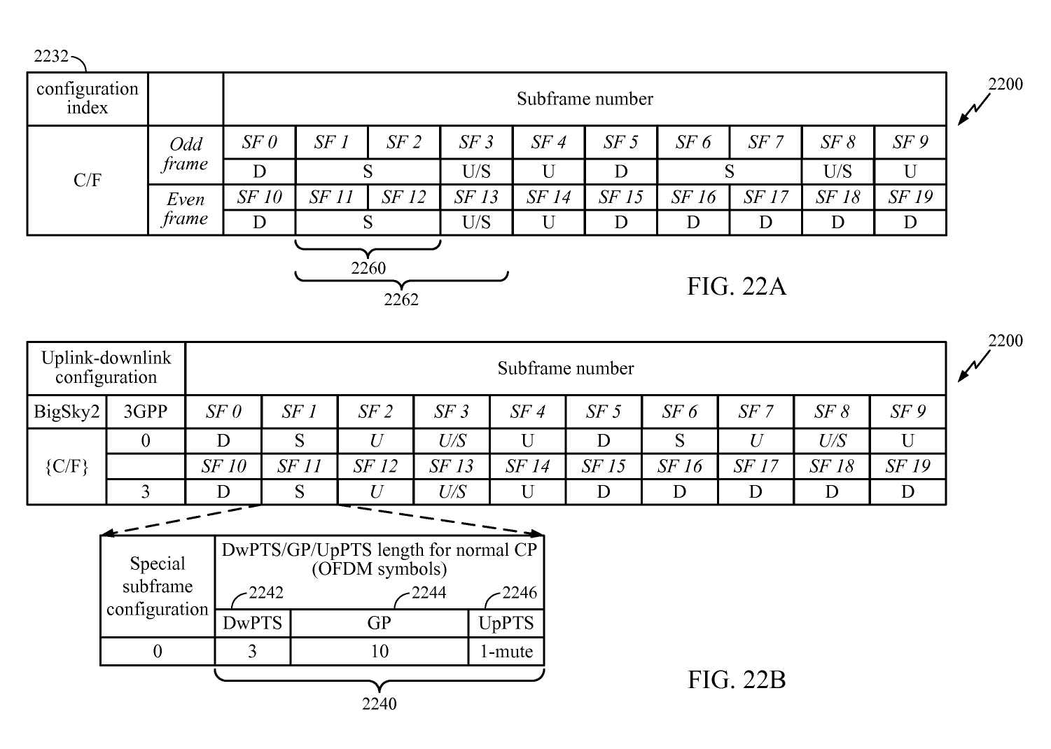

Categorizing the air cell 2100 into multiple zones to support extended cell radii involves a tradeoff between system capacity and cell coverage. Using a two (2) millisecond extended special subframe (FIGS. 16A-17B) involves less guard time overhead (e.g., reasonable system throughput), but cell coverage is limited to 250 kilometers. Using a three (3) millisecond extended special subframe (FIGS. 18A-19B) provides larger cell coverage with less system throughput (e.g., more guard time overhead). By subdividing the air cell 2100 into multiple zones, one aspect of the present disclosure enables coexistence between the two (2) millisecond extended special subframe and the three (3) millisecond extended special subframe by providing a nested frame structure, for example, as shown in FIGS. 22A and 22B. Although described with reference to specific distances, the various zones of the present disclosure are not limited to these specific distances.

Referring again to FIG. 21, in one configuration, the base station (eNodeB) applies the two (2) millisecond extended special subframe when an aircraft transceiver (AT) is detected with a first extended cell radius. For example, the eNodeB applies a first extended special subframe (e.g., Next-Gen AG system configuration C) for communication with AT 1, which is detected within Zone 1. Similarly, the eNodeB applies a second extended special subframe (e.g., Next-Gen AG system configuration F) for communication with AT 2, which is detected within Zone 2. Based on this configuration, most aircraft are within Zone 1 and operate with high system capacity by using the first extended special subframe. Conversely, only a few cell-edge aircrafts are within Zone 2 in which a longer guard time is applied to prevent overlap between downlink and uplink transmissions.

FIG. 22A is a block diagram illustrating a nested frame structure 2200 according to one aspect of the present disclosure. This configuration of a nested frame structure 2200 enables support for both a first extended special subframe 2250 and a second extended special subframe 2252. The nested frame structure 2200 may switch between a first extended special subframe 2250 that extends over subframes SF 1 and SF 2 (SF 6 and SF 7, SF 11 and SF 12) and a second extended special subframe 2452 that extends over subframes SF 1 to SF 3 (SF 6 to SF 8 and SF 11 to SF 13). This nested frame structure 2200 supports switching between Next-Gen AG system configurations C and F, as noted by the configuration index 2232. In this configuration, the Next-Gen AG system configurations C and F dynamically switch between uplink-downlink configuration zero (0) and uplink-downlink configuration three (3), as shown in FIG. 12. For example, even subframes may use uplink-downlink configuration zero (0) and odd subframes may use uplink-downlink configuration three (3).

FIG. 22B further illustrates an extended special subframe 2240 according to another aspect of the present disclosure. The extended special subframe 2240 includes a downlink pilot time slot (DwPTS) portion 2242 and a guard period (GP) portion 2244. An uplink pilot time slot (UpPTS) portion 2246 is omitted (e.g., muted) to extend the guard period (GP) portion 2244 of the extended special subframe 2240. In this configuration, the DwPTS portion 2242 of the extended special subframe 2240 is treated as a regular, but shortened downlink subframe.

In this configuration, the special subframe configuration zero (0) is also applied while muting the UpPTS portion 2246. The UpPTS portion 2246 may be muted by not scheduling any sounding reference signals. In this example, when an aircraft is in Zone 1, uplink subframes SF 2, SF 7 and SF 12 are muted to provide the extended special subframe 2240. In this example the extended special subframe is configured as the first extended special subframe 2250 having a two (2) millisecond duration, as shown in FIG. 22A. In addition, when an aircraft is in Zone 2, uplink subframes SF 2 and SF 3, SF 7 and SF 8, as well as uplink subframes SF 12 and SF 13 are muted to provide the second extended special subframe 2252 having a three (3) millisecond duration, as shown in FIG. 22A.

The uplink subframes may be muted by not scheduling any uplink data transmissions during these uplink subframes. Muting these uplink subframes may also involve moving any acknowledgement (ACK)/negative acknowledgement (NACK) feedback to a next suitable subframe. Also, any channel quality information (CQI), precoding matrix indicator, and/or rank indicator information is not reported during these muted, uplink subframes. In addition, no sounding reference signal (SRS), scheduling request (SR), and/or random access channel (RACH) transmission are performed during these uplink subframes.

FIG. 23 illustrates a further categorization of air cells 2300 (2300-1, 2300-2 and 2300-3) into multiple zones to support extended cell radii according to one aspect of the present disclosure. In this configuration, the air cells 2300 include a first zone (Zone 1) for aircraft transceivers (ATs) that are less than two-hundred fifty (250) kilometers from a base station (e.g., eNodeB). The air cells 2300 also include a second zone (Zone 2) for aircraft transceivers (ATs) that are greater than two-hundred fifty (250) kilometers from a base station (e.g., eNodeB). In this example, a first aircraft transceiver AT 1 is in a first zone (Zone 1) of a first air cell 2300-1, and a second aircraft transceiver AT 2 is in a second zone (Zone 2) at a cell-edge of a third air cell 2300-3.

Using the nested frame structure 2200 by a base station involves categorization of aircraft within the various zones of the air cells 2300. The base station uses the instantaneous location of all serving aircraft to categorize the aircraft within the various zones of the air cells 2300. In one configuration, position location logic at each served aircraft transceiver (AT) communicates a zone index to the base station via a physical uplink shared channel (PUSCH), a physical uplink control channel (PUCCH), a physical uplink random access channel (PRACH) or other like uplink channels. In another configuration, position location logic of the base station computes a zone index of each served aircraft transceiver (AT). The position location logic may be a global position system (GPS), differential GPS, or other position detection scheme.

In this example, the first air cell 2300-1 is supported by eNodeB A, the second air cell 2300-2 is supported by eNodeB B, and the third air cell 2300-2 is supported by eNodeB C. In addition, a first aircraft transceiver AT 1 is less than two-hundred fifty (250) kilometers from the eNodeB A, while a second aircraft transceiver AT 2 is greater than two-hundred fifty (250) kilometers from eNodeB C at the cell-edge of the third air cell 2300-3. Due to the increased timing advance applied at the base station for supporting the extended special subframes, uplink transmissions from aircrafts (e.g., AT 1) in Zone 1 may generate interference to neighbor cell's downlink transmission to aircraft (e.g., AT 2) in Zone 2.

In this configuration, uplink-to-downlink interference is mitigated by the directional antenna pattern at AT 1 and AT 2. That is, the interference over thermal noise (IoT) is quite small due to the roll-off in azimuth and elevation angle of the aircraft antenna relative to the boresight. In another configuration, the size of Zone 1 is reduced to avoid the uplink-to-downlink overlap. In a further configuration, the base station adjusts the uplink scheduling depending on the aircraft location. In this example, uplink transmission of AT 1 in Zone 1 are scheduled in subframes SF 3, SF 4, SF 8, SF 9, SF 13 and SF 14, as shown in FIG. 22. When AT 2 is in Zone 2, subframes SF 3, SF 8 and SF 13 are muted.

Reliable communication within a next generation air to ground (Next-Gen AG) system may involve techniques for retransmitting data when the data is not successfully received at a target location. For example, an automatic repeat request (ARQ) protocol may be used by an aircraft that receives data (e.g., UE 650) to request retransmission of various portions of the data when an initial transmission from a base station (e.g., eNodeB) is unsuccessful. Hybrid ARQ (HARQ) combines retransmission of data with error correction techniques and/or other techniques for improving the robustness of transmissions conducted within the Next-Gen AG system.

In physical layer specifications such as TD-LTE, a UE and an eNodeB may employ a HARQ scheme to improve data throughput and increase transmission reliability. The HARQ scheme provides transmission reliability by temporarily storing decision metrics that can be combined with subsequent decision metrics from data retransmissions. The decision metric may refer to a posterior probability or likelihood (soft value) of transmitted bits being a “0” or a “1” including, but not limited to, log-likelihood ratios (LLRs). Groups of such decision metrics may be used by a decoder to decode a transmitted sequence (e.g., a transport block).

TD-LTE provides physical layer support for HARQ on the physical downlink shared channel (PDSCH) and the physical uplink shared channel (PUSCH). In addition, TD-LTE provides physical layer support for sending associated acknowledgment feedback over separate control channels. In a Next-Gen AG system, transmission conducted pursuant to HARQ is performed in the context of one or more HARQ processes. These HARQ process can be managed by a HARQ controller at the aircraft (e.g., UE 650) and or similar mechanisms of the base station (e.g., eNodeB 610). A maximum number of HARQ processes is determined by an uplink/downlink configuration.

In a Next-Gen AG system, however, an extended special subframe is communicated by transmitting a special subframe that extends over an uplink pilot time slot and one or more disabled, adjacent uplink subframes. These adjacent uplink subframes may be disabled (e.g., muted) by not scheduling any uplink data transmissions during these adjacent, uplink subframes. Muting these adjacent uplink subframes may also involve moving any acknowledgement (ACK)/negative acknowledgement (NACK) feedback to a next suitable subframe.

In one configuration, ACK/NACK feedback for a physical downlink shared channel (PDSCH) transmission is moved to a next suitable uplink subframe by adjusting a downlink association set K. In addition, support of an increased, minimum response time is specified to deal with the larger propagation delay in the Next-Gen AG system due to the extended cell radii. In addition, retransmissions for asynchronous HARQ may be rescheduled via the physical downlink control channel (PDCCH) to allow for more flexible scheduling.

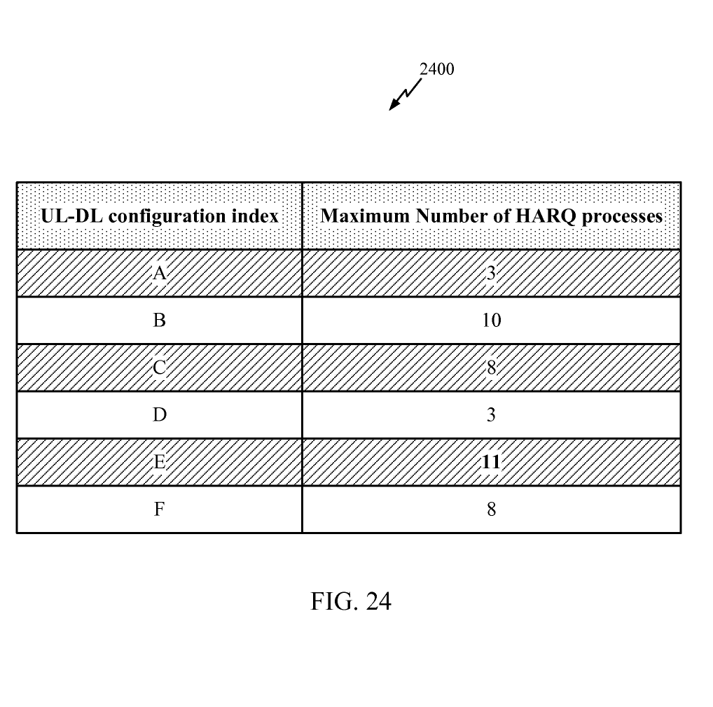

The absence of an ACK/NACK feedback in the extended special subframes and increased minimum response time (due to the extended cell radii) also involve a modification in the maximum number of HARQ processes. For example, as shown in table 2400 of FIG. 24, the maximum number of downlink HARQ processes may vary according to an uplink/downlink configuration index of the Next-Gen AG system.

Retransmissions from HARQ processes are triggered by receipt of ACK/NACK feedback (e.g., NACK feedback). Conventionally, a UE transmits ACK/NACK feedback in uplink subframe n in response to a PDSCH transmission within subframes n-k, e.g., the minimum value of k is 4. This allows for at least 3 milliseconds processing time at the UE. In one configuration, a longer ACK/NACK response time (e.g., k≧6) may be specified to meet an aircraft transceiver (AT) processing time and an increased propagation delay due to the extended cell radii in the Next-Gen AG system. In addition, a processing time, e.g., three milliseconds, at the base station may be maintained.

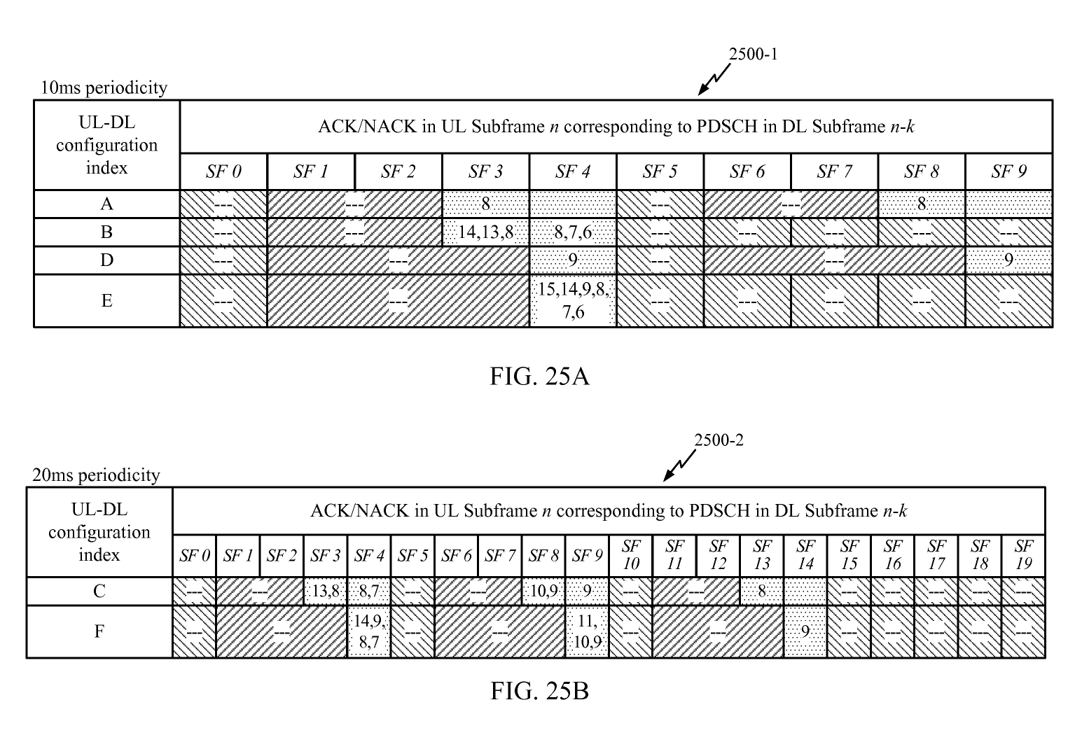

FIG. 25A illustrates a configuration of a TD-LTE radio frame structure 2500-1 including tables of downlink association set indexes, which represent the timing of ACK/NACK feedback when communicating with an extended special subframe specified to support the noted, extended cell radii. The TD-LTE radio frame structure 2500-1 has a ten (10) millisecond periodicity with extended special subframes that extend over subframes SF 1, SF 2 (e.g., Next-Gen AG system configurations A and B) and also SF 3 (e.g., Next-Gen AG system configurations D and E). The TD-LTE radio frame structure 2500-1 also includes extended special subframes that extend over subframes SF 6, SF 7 (e.g., configuration A) and SF 8 (e.g., configuration D).

In this configuration, ACK/NACK feedback in uplink subframe SF n corresponds to a physical downlink shared channel (PDSCH) transmission in downlink subframe SF n-k. In this configuration, k is determined according to downlink association set K in which the value of k is adjusted so that ACK/NACK feedback for downlink subframes is moved to a next suitable uplink subframe. The downlink association set K, including the adjusted k values may, for example, replace Table 10.1-1 in 3GPP TS 36.213.

In Next-Gen AG system configuration A, a value of k=8 is indicated for uplink subframes SF 3 and SF 8. This means that ACK/NACK feedback for downlink subframe SF 5 of the previous radio frame (not shown) is provided in uplink subframe SF 3 of the current radio frame. In addition, ACK/NACK feedback for downlink subframe SF 0 of the current radio frame 2500-1 is provided in uplink subframe SF 8.

Similarly, in Next-Gen AG system configuration D, a value of k=9 is indicated for uplink subframes SF 4 and SF 9. This means that ACK/NACK feedback for downlink subframe SF 5 of the previous radio frame (not shown) is provided in uplink subframe SF 4 of the current radio frame. In addition, ACK/NACK feedback for downlink subframe SF 0 of the current radio frame 2500-1 is provided in uplink subframe SF 9.

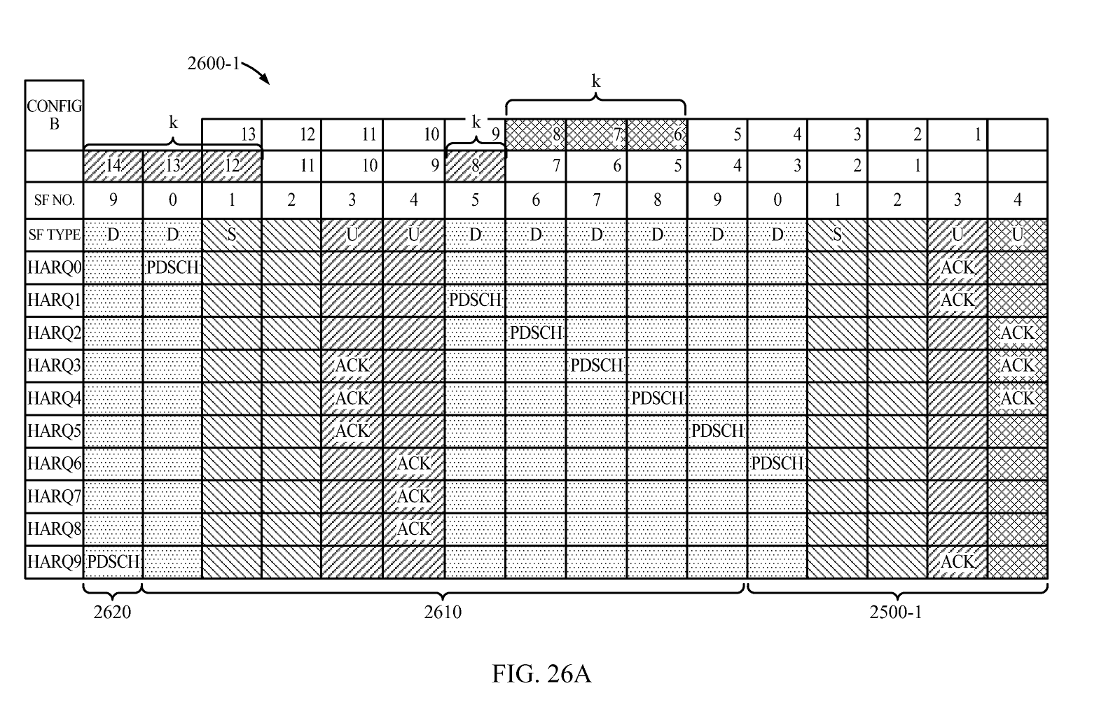

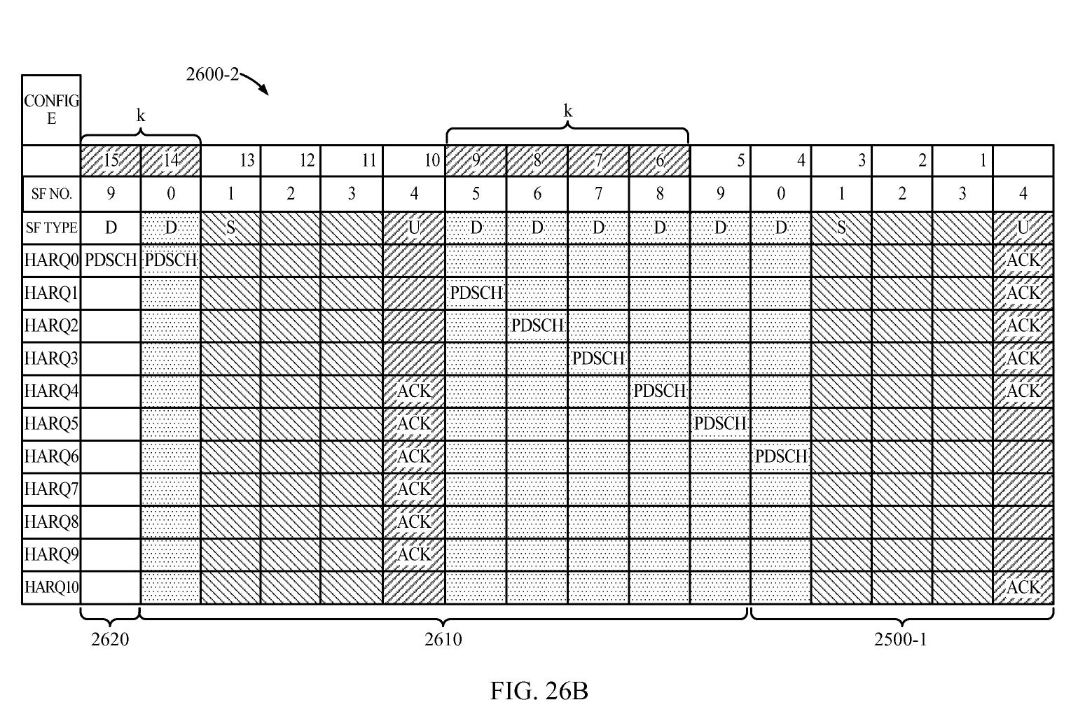

Note that the number of downlink subframes are less than or equal to the number of uplink subframes with Next-Gen AG system configurations A and D. Hence, there is at most one ACK/NACK feedback for PDSCH transmissions in each of uplink subframes for Next-Gen AG system configurations A and D. By contrast, providing ACK/NACK feedback for PDSCH transmissions with Next-Gen AG system configurations B and E involves multiple ACK/NACK feedbacks in a single uplink subframe (e.g., SF 3 and SF 4) since the number of downlink subframes are more than the number of uplink subframes. In addition, the number of uplink subframes is reduced in Next-Gen AG system due to the extended special subframes. This process is further illustrated in FIGS. 26A and 26B, in which ACK/NACK Feedback Tables 2600-1 and 2600-2 further illustrate the process for determining downlink association set index k to provide the ACK/NACK feedback for PDSCH transmission in Next-Gen AG system configurations B and E. This process is further illustrated in FIGS. 26A and 26B, in which ACK/NACK Feedback Tables 2600-1 and 2600-2 further illustrate the process for determining k to provide the ACK/NACK feedback for Next-Gen AG system configurations B and E.

ACK/NACK Feedback Table 2600-1 of FIG. 26A illustrates the process for determining downlink association set index k and the maximum downlink HARQ processes for Next-Gen AG system configuration B. For example, in Next-Gen AG system configuration B, values of k=14, k=13 and k=8 are specified for uplink subframe SF 3 of the TD-LTE radio frame structure 2500-1. This means that ACK/NACK feedbacks for downlink subframe SF 9 (corresponding to k=14) from 2 radio frames ahead, and downlink subframes SF 0 (corresponding to k=13) and SF 5 (corresponding to k=8) of the previous radio frame are provided in uplink subframe SF 3 of the current radio frame. In this example, k=12 is not in the downlink association set because it is assumed that no data is sent during a special subframe SF 1 of the TD-LTE radio frame structure 2610. That is, although control data (e.g., uplink grants) may be sent during the DwPTS (e.g., the first 3 OFDM symbols) of a special subframe, PDSCH is not sent during the DwPTS of the special subframe.

In Next-Gen AG system configuration B, values of k=8, k=7 and k=6 are specified for uplink subframe SF 4 of the TD-LTE radio frame structure 2500-1. This means that ACK/NACK feedbacks for downlink subframes SF 6 (corresponding to k=8), SF 7 (corresponding to k=7) and SF 8 (corresponding to k=6) of the previous radio frame is provided in uplink subframe SF 4 of the current radio frame.

ACK/NACK Feedback Table 2600-2 of FIG. 26B illustrates the process for determining downlink association set index k and the maximum downlink HARQ processes for Next-Gen AG system configuration E. In Next-Gen AG system configuration E, values of k=15, k=14, k=9, k=8, k=7 and k=6 are specified for uplink subframe SF 4. This means that ACK/NACK feedbacks for downlink subframe SF 9 (corresponding to k=15) from 2 radio frames ahead, and downlink subframes SF 0 (corresponding to k=14), SF 5 (corresponding to k=9), SF 6 (corresponding to k=8), SF 7 (corresponding to k=7) and SF 8 (corresponding to k=6) of the previous radio frame are provided in uplink subframe SF 4 of the current radio frame.

FIG. 25B illustrates a configuration of a TD-LTE radio frame structure 2500-2 including tables of downlink association set indexes, which represent the timing of ACK/NACK feedback when communicating with an extended special subframe specified to support extended cell radii. The TD-LTE radio frame structure 2500-2 has a twenty (20) millisecond periodicity with extended special subframes that extend over subframes SF 1, SF 2, subframes SF 6 and SF 7, and subframes SF 11 and SF 12 (e.g., Next-Gen AG system configuration C). In addition, extended special subframes extend over subframes SF 1 to SF 3, subframes SF 6 to SF 8, and subframes SF 11 to SF 13 in Next-Gen AG system configuration F.

In Next-Gen AG system configuration C, values of k=13 and k=8 are specified for uplink subframe SF 3 and values of k=8 and k=7 are specified for uplink subframe SF 4 of the TD-LTE radio frame structure 2500-2. This means that ACK/NACK feedbacks for downlink subframes SF 10 (corresponding to k=13) and SF 15 (corresponding to k=8) of the previous radio frame (not shown) are provided in uplink subframe SF 3 of the current radio frame. In addition, ACK/NACK feedback for downlink subframes SF 16 (corresponding to k=8) and SF 17 (corresponding to k=7) of the previous radio frame are provided in uplink subframe SF 4 of the current radio frame.

In this example, values of k=10, k=9 are specified for uplink subframe SF 8; a value of k=9 is specified for uplink subframe SF 9; and a value of k=8 is specified for uplink subframe SF 13 of the TD-LTE radio frame structure 2500-2. This means that ACK/NACK feedbacks for downlink subframes SF 18 (corresponding to k=10) and SF 19 (corresponding to k=9) of the previous radio frame are provided in uplink subframe SF 8 of the current radio frame. In addition, ACK/NACK feedback for downlink subframe SF 0 (corresponding to k=9) of the current radio frame is provided in uplink subframe SF 9 of the current radio frame. Similarly, ACK/NACK feedback for downlink subframe SF 5 (corresponding to k=8) of the current radio frame is provided in uplink subframe SF 13.

In Next-Gen AG system configuration F, values of k=14, k=9, k=8 and k=7 are specified for uplink subframe SF 4. This means that ACK/NACK feedback for downlink subframes SF 10 (corresponding to k=13), SF 15 (corresponding to k=9), SF 16 (corresponding to k=8) and SF 17 (corresponding to k=7) of the previous radio frame (not shown) are provided in uplink subframe SF 4 of the current radio frame. In addition, values of k=11, k=10 and k=9 are specified for uplink subframe SF 9 and a value of k=9 is specified for uplink subframe SF 14 of the TD-LTE radio frame structure 2500-2. This means that ACK/NACK feedback for downlink subframes SF 18 (corresponding to k=11) and SF 19 (corresponding to k=10) of the previous radio frame and ACK/NACK feedback for downlink subframe SF 0 (corresponding to k=9) of the current radio frame are provided in uplink subframe SF 9. In addition, ACK/NACK feedback for downlink subframe SF 5 (corresponding to k=9) of the current radio frame is provided in uplink subframe SF 14.

As noted, an extended special subframe is communicated in a Next-Gen AG system by transmitting a special subframe that extends over an uplink pilot time slot and one or more disabled, adjacent uplink subframes. These adjacent uplink subframes may be disabled (e.g., muted) by not scheduling any uplink data transmissions during these adjacent, uplink subframes. Muting these adjacent uplink subframes may also involve suspending any uplink grants associated with a muted uplink subframe. In addition, the relative timing of between an uplink grant and the corresponding PUSCH transmission may be modified to ensure an increased minimum response time from an aircraft transceiver due to the extended cell radii.

In one configuration, the uplink grant related modification is achieved by adjusting an uplink association index K_{PUSCH}. In addition, an increased, minimum response time is specified to deal with the larger propagation delays in the Next-Gen AG system due to the extended cell radii. Furthermore, retransmissions for synchronous HARQ may be indicated via the physical HARQ indicator channel (PDCCH) to allow for a more simplified implementation with reduced signaling overhead.

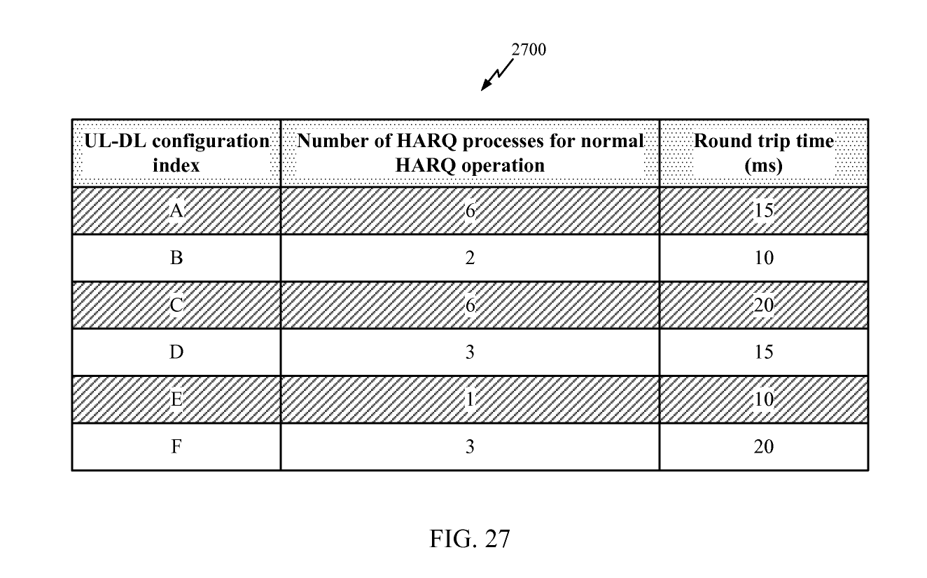

The use of extended special subframes also involves a reduction in the number of uplink HARQ processes. For example, as shown in table 2700 of FIG. 27, the number of uplink HARQ processes may vary according to an uplink/downlink configuration index of the Next-Gen AG system. For example, as shown in table 2700 of FIG. 27, the number of HARQ processes may vary according to an uplink/downlink configuration index of the Next-Gen AG system. In this example, a maximum number of HARQ processes may be limited to seven (7). In this configuration, retransmission is indicated via a physical HARQ indicator channel (PHICH) or a new uplink grant on a physical downlink control channel (PDCCH).

In one configuration, a physical uplink shared channel response time (e.g., k>6) may be specified to meet an aircraft transceiver (AT) processing time and an increased propagation delay due to the extended zones in the Next-Gen AG system. In addition, a processing time (e.g., three milliseconds) at the base station is presumed in the Next-Gen AG system.

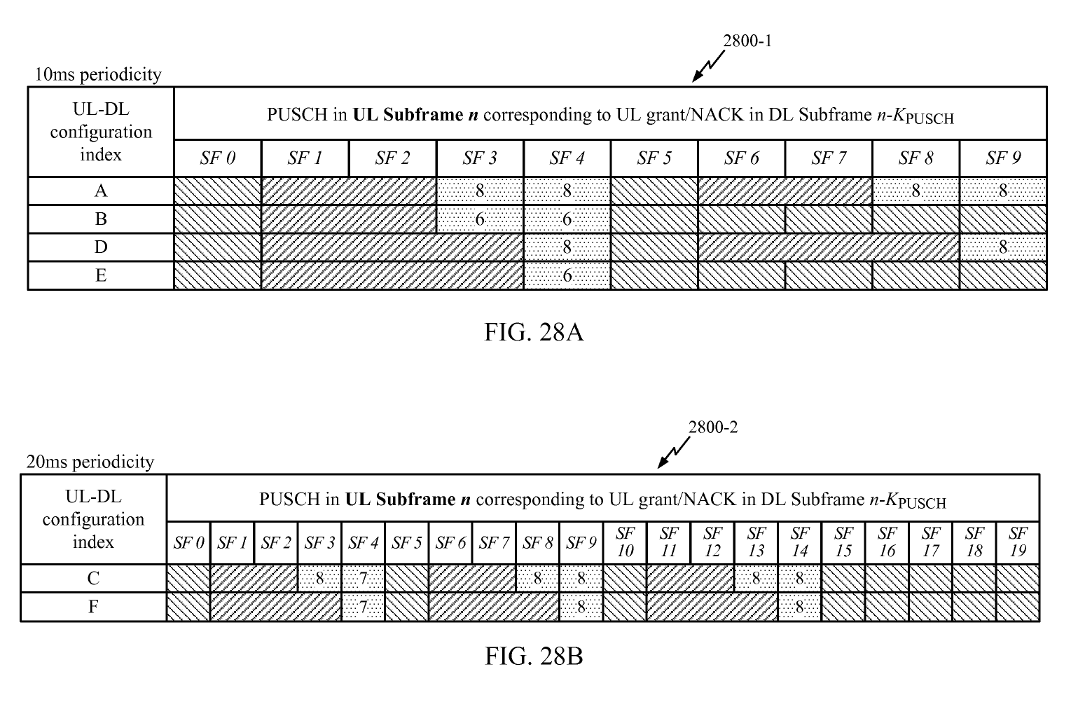

FIG. 28A illustrates a configuration of a TD-LTE radio frame structure 2800-1 including physical uplink shared channel (PUSCH) data transmission when communicating with an extended special subframe. The TD-LTE radio frame structure 2800-1 also has a ten (10) millisecond periodicity with extended special subframes that extend over subframes SF 1, SF 2 (e.g., Next-Gen AG system configurations A and B) and also SF 3 (e.g., Next-Gen AG system configurations D and E). The TD-LTE radio frame structure 2800-1 also includes extended special subframes that extend over subframes SF 6, SF 7 (e.g., configuration A) and SF 8 (e.g., configuration D).

In this configuration, a physical uplink shared channel (PUSCH) transmission of data in uplink subframe SF n corresponds to an uplink grant sent in a subframe SF n-K_{PUSCH}. That is, a UE may transmit a new data package or retransmit an old package on a physical uplink shared channel (PUSCH) in an uplink subframe SF n. In this configuration, the PUSCH transmission in the uplink subframe SF n corresponds to a scheduling command transmitted on a physical downlink control channel (PDCCH) in a subframe SF n-K_{PUSCH}. The PUSCH transmission in the uplink subframe SF n may also correspond to a NACK transmitted on a physical HARQ indicator channel (PHICH) in a subframe SF n-K_{PUSCH}. The uplink subframe SF n may also correspond to a NACK transmitted on a physical HARQ indicator channel (PHICH) in a subframe SF n-K_{PUSCH}. The uplink grant/NACK may be sent in a downlink subframe or a special subframe. In this configuration, K_{PUSCH} is determined according to an Uplink Association Index Table in which the value of K_{PUSCH} is adjusted so that no uplink grant/NACK is associated with a muted uplink subframe. The uplink grant/NACK may be sent in a downlink subframe or an extended special subframe. In this configuration, K_{PUSCH} is determined according to an Uplink Association Index Table in which the value of K_{PUSCH} is adjusted so that no uplink grant/NACK is associated with an extended special subframe. The Uplink Association Index Table, including the adjusted K_{PUSCH} values may, for example, replace Table 5.1.1.1-1 (K_{PUSCH}) and Table 7.3-Y (k′) in 3GPP TS 36.213.

FIG. 28A further illustrates the Next-Gen AG system configuration A in which a value of K_{PUSCH}=8 is indicated for uplink subframes SF 3, SF 4, SF 8 and SF 9. Based on this value of K_{PUSCH}, a PUSCH transmission (e.g., a new data package or a retransmitted package) is transmitted in uplink subframe SF 3 in response to an uplink grant/NACK in a downlink subframe SF 5 from a previous radio frame (not shown). In addition, a PUSCH transmission is transmitted in uplink subframe SF 4 in response to an uplink grant/NACK in a special subframe SF 6 from the previous radio frame. Similarly, a PUSCH transmission is transmitted in uplink subframe SF 8 in response to an uplink grant/NACK in a downlink subframe SF 0 from the current radio frame. In addition, a PUSCH transmission is transmitted in uplink subframe SF 9 in response to an uplink grant/NACK in a special subframe SF 1 from the current radio frame.

In Next-Gen AG system configuration B, a value of K_{PUSCH}=6 is specified for uplink subframes SF 3 and SF 4. Based on this value of K_{PUSCH}, a PUSCH transmission is transmitted in uplink subframe SF 3 in response to an uplink grant/NACK in a downlink subframe SF 7 from a previous radio frame (not shown). In addition, a PUSCH transmission is transmitted in uplink subframe SF 4 in response to an uplink grant/NACK in a downlink subframe SF 8 from the previous radio frame. Similarly, in Next-Gen AG system configuration E, a value of K_{PUSCH}=6 is specified for uplink subframe SF 4. Based on this value of K_{PUSCH}, a PUSCH transmission is transmitted in uplink subframe SF 4 in response to an uplink grant/NACK in a downlink subframe SF 8 from the previous radio frame.

In Next-Gen AG system configuration D, a value of K_{PUSCH}=8 is specified for uplink subframes SF 4 and SF 9. Based on this value of K_{PUSCH}, a PUSCH transmission is transmitted in uplink subframe SF 4 in response to an uplink grant/NACK in a special subframe SF 6 from a previous radio frame (not shown). In addition, a PUSCH transmission is transmitted in uplink subframe SF 9 in response to an uplink grant/NACK in a special subframe SF 1 from the current radio frame.

FIG. 28B illustrates a configuration of a TD-LTE radio frame structure 2800-2 including physical uplink shared channel (PUSCH) data transmission when communicating with an extended special subframe. The TD-LTE radio frame structure 2800-2 has a twenty (20) millisecond periodicity with extended special subframes that extend over subframes SF 1, SF 2, subframes SF 6 and SF 7, and subframes SF 11 and SF 12 (e.g., Next-Gen AG system configuration C). In addition, extended special subframes extend over subframes SF 1 to SF 3, subframes SF 6 to SF 8, and subframes SF 11 to SF 13 (e.g., Next-Gen AG system configuration F).

In Next-Gen AG system configuration C, a value of K_{PUSCH}=8 is specified for uplink subframes SF 3, SF 8, SF 9 SF 13 and SF 14. In addition, a value of K_{PUSCH}=7 is specified for an uplink subframe SF 4. Based on the value of K_{PUSCH}=8, a PUSCH transmission is transmitted in uplink subframe SF 3 in response to an uplink grant/NACK in a downlink subframe SF 15 from a previous radio frame (not shown). Based on the value of K_{PUSCH}=7, a PUSCH transmission is transmitted in uplink subframe SF 4 in response to an uplink grant/NACK in a downlink subframe SF 17 from the previous radio frame.

In addition, a PUSCH transmission is transmitted in uplink subframe SF 8 in response to an uplink grant/NACK in a downlink subframe SF 0 from the current radio frame. Similarly, a PUSCH transmission is transmitted in uplink subframe SF 9 in response to an uplink grant/NACK in a special subframe SF 1 of the current radio frame. In addition, a PUSCH transmission is transmitted in uplink subframe SF 13 in response to an uplink grant/NACK in a downlink subframe SF 5 of the current radio frame. Also, a PUSCH transmission is transmitted in uplink subframe SF 14 in response to an uplink grant/NACK in a special subframe SF 6 of the current radio frame.

In Next-Gen AG system configuration F, a value of K_{PUSCH}=7 is specified for uplink subframe SF 4. Based on the value of K_{PUSCH}=7, a PUSCH transmission is transmitted in uplink subframe SF 4 in response to an uplink grant/NACK in a downlink subframe SF 17 from a previous radio frame (not shown). Based on the value of K_{PUSCH}=8, a PUSCH transmission is transmitted in uplink subframe SF 9 in response to an uplink grant/NACK in a special subframe SF 1 from the current radio frame. In addition, a PUSCH transmission is transmitted in uplink subframe SF 14 in response to an uplink grant/NACK in a special subframe SF 6 from the current radio frame.

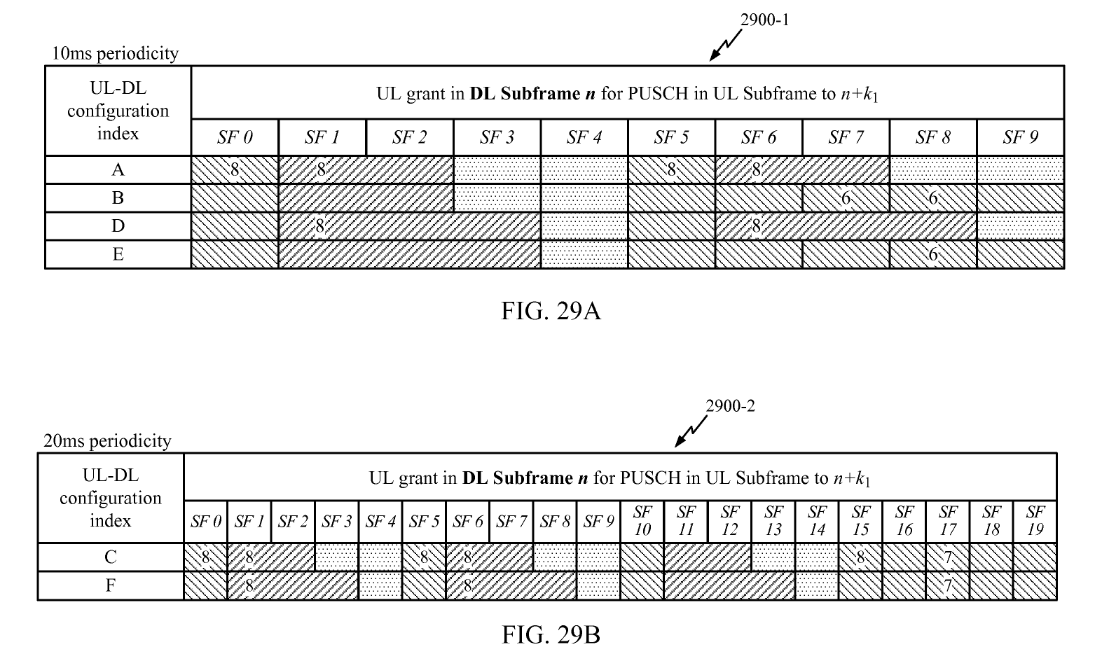

FIG. 29A and FIG. 29B illustrate a configuration of a TD-LTE radio frame structure 2900-1 including the timing of uplink grants transmitted by a base station (e.g., eNodeB) for physical uplink shared channel (PUSCH) data transmission when communicating with an extended special subframe. The TD-LTE radio frame structure 2900-1 also has a ten (10) millisecond periodicity with extended special subframes that extend over subframes SF 1, SF 2 (e.g., Next-Gen AG system configurations A and B) and also SF 3 (e.g., Next-Gen AG system configurations D and E). The TD-LTE radio frame structure 2900-1 also includes extended special subframes that extend over subframes SF 6 and SF 7 (e.g., configuration A) and SF 8 (e.g., configuration D).

In this aspect, a physical uplink shared channel (PUSCH) transmission of data in an uplink subframe SF n+K₁ is in response to an uplink grant/NACK transmitted in a subframe SF n. That is, a UE may detect a PDCCH transmission that includes a uplink grant and/or detect a PHICH transmission that includes a NACK in a subframe SF n that is intended for the UE. In response, the UE sends the corresponding PUSCH transmission in the uplink subframe SF n+K₁. In this aspect, the K₁ values may, for example, replace Table 8-2 in 3GPP TS 36.213. Those tables in FIGS. 29A and 29B represent the same information as the tables in FIGS. 28A and 28B about the relative timing between an uplink grant/NACK and the corresponding PUSCH transmission with K₁=K_{PUSCH}, but in a different way of descriptions.

FIG. 29A further illustrates Next-Gen AG system configuration A in which a value of K₁=8 is specified for downlink subframes SF 0 and SF 5 as well as special subframes SF 1 and SF 6. Similarly, in Next-Gen AG system configuration D, the value of K₁=8 is specified for special subframes SF 1 and SF 6. Based on this value of K₁, a data package is transmitted in uplink subframe SF 8 of the TD-LTE radio frame structure 2900-1 in response to an uplink grant in the downlink subframe SF 0. In addition, a data package is transmitted in uplink subframe SF 9 of the TD-LTE radio frame structure 2900-1 in response to an uplink grant in the special subframe SF 1. Similarly, in Next-Gen AG system configuration D, a data package is also transmitted in uplink subframe SF 9 of the TD-LTE radio frame structure 2900-1 in response to an uplink grant in the special subframe SF 1.

In Next-Gen AG system configuration A, a data package is transmitted in an uplink subframe SF 3 of a subsequent TD-LTE radio frame structure (not shown) in response to an uplink grant in the downlink subframe SF 5. In addition, a data package is transmitted in an uplink subframe SF 4 of the subsequent TD-LTE radio frame structure in response to an uplink grant in the special subframe SF 6. Similarly, in Next-Gen AG system configuration D, a data package is transmitted in an uplink subframe SF 4 of the subsequent TD-LTE radio frame structure in response to an uplink grant in the special subframe SF 6.

In Next-Gen AG system configuration B, a value of K₁=6 is specified for downlink subframes SF 7 and SF 8. Based on this value of K₁, a data package is transmitted in an uplink subframe SF 3 of a subsequent TD-LTE radio frame structure (not shown) in response to the uplink grant in the downlink subframe SF 8. In addition, a data package is transmitted in an uplink subframe SF 4 of the subsequent TD-LTE radio frame structure in response to an uplink grant in a downlink subframe SF 8. Similarly, in Next-Gen AG system configuration E, a value of K₁=6 is specified for a downlink subframe SF 8. Based on this value of K₁, a data package is transmitted in an uplink subframe SF 4 of a subsequent TD-LTE radio frame structure (not shown) in response to an uplink grant in the downlink subframe SF 8.

FIG. 29B illustrates a configuration of a TD-LTE radio frame structure 2900-2 including uplink grants for physical uplink shared channel (PUSCH) data transmission when communicating with an extended special subframe. The TD-LTE radio frame structure 2900-2 has a twenty (20) millisecond periodicity with extended special subframes that extend over subframes SF 1, SF 2, subframes SF 6 and SF 7, and subframes SF 11 and SF 12 (e.g., Next-Gen AG system configuration C). In addition, extended special subframes extend over subframes SF 1 to SF 3, subframes SF 6 to SF 8, and subframes SF 11 to SF 13 (e.g., Next-Gen AG system configuration F).

In Next-Gen AG system configuration C, a value of K₁=8 is specified for downlink subframes SF 0, SF 5 and SF 15 as well as special subframes SF 1 and SF 6. In addition, a value of K₁=7 is specified for a downlink subframe SF 17. Based on the value of K₁=8, a data package is transmitted in an uplink subframe SF 8 of the TD-LTE radio frame structure 2900-2 in response to an uplink grant in the downlink subframe SF 0. In addition, a data package is transmitted in an uplink subframe SF 9 of the TD-LTE radio frame structure 2900-2 in response to an uplink grant in the special subframe SF 0. A data package is also transmitted in an uplink subframe SF 13 of the TD-LTE radio frame structure 2900-2 in response to an uplink grant in the downlink subframe SF 5.

In this example, a data package is also transmitted in an uplink subframe SF 14 of the TD-LTE radio frame structure 2900-2 in response to an uplink grant in the special subframe SF 6. In addition, a data package is transmitted in an uplink subframe SF 3 of a subsequent TD-LTE radio frame structure (not shown) in response to an uplink grant in the downlink subframe SF 15. Based on the value of K₁=7, a data package is also transmitted in an uplink subframe SF 4 of the subsequent TD-LTE radio frame structure in response to an uplink grant in the downlink subframe SF 17.

In Next-Gen AG system configuration F, a value of K₁=8 is specified for uplink subframes SF 1 and SF 6. In addition, a value of K₁=7 is specified for a downlink subframe SF 17. Based on the value of K₁=8, a data package is transmitted in an uplink subframe SF 9 of the TD-LTE radio frame structure 2900-2 in response to an uplink grant in the special subframe SF 1. A data package is also transmitted in an uplink subframe SF 14 of the TD-LTE radio frame structure 2900-2 in response to an uplink grant in the special subframe SF 6. Based on the value of K₁=7, a data package is transmitted in an uplink subframe SF 4 of a subsequent TD-LTE radio frame structure (not shown) in response to an uplink grant in the downlink subframe SF 17.

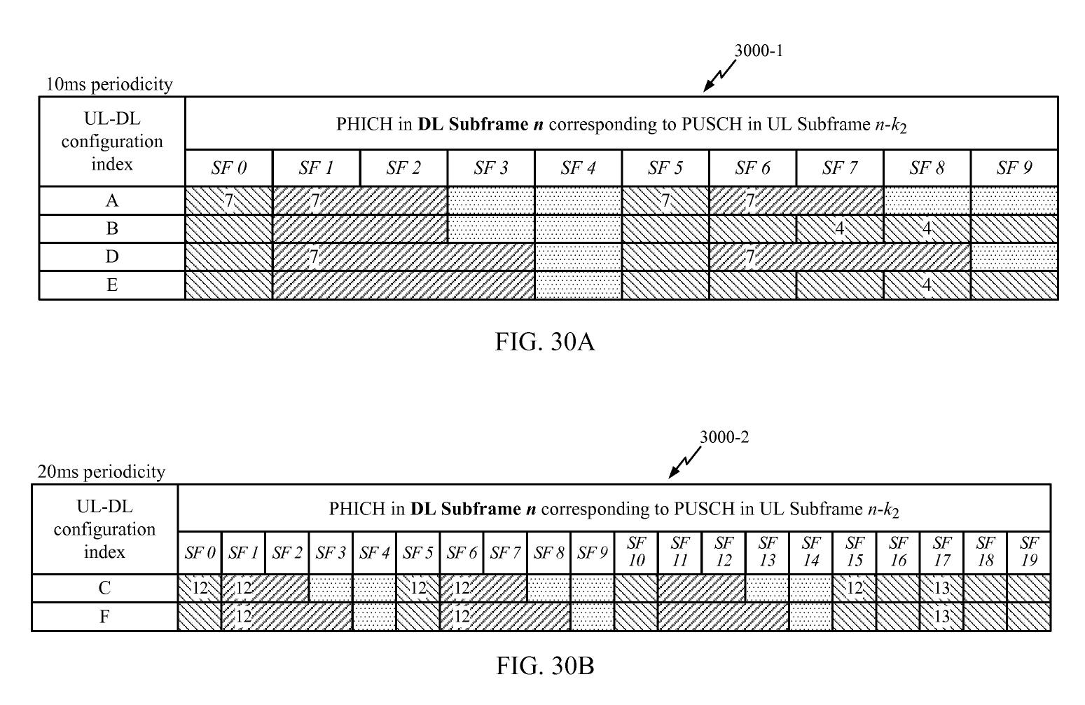

FIG. 30A illustrates a configuration of a TD-LTE radio frame structure 2500-1 including the timing of ACK/NACK feedback received on a physical HARQ indicator channel (PHICH) when communicating with an extended special subframe. The TD-LTE radio frame structure 3000-1 also has a ten (10) millisecond periodicity with extended special subframes that extend over subframes SF 1, SF 2 (e.g., Next-Gen AG system configurations A and B) and also SF 3 (e.g., Next-Gen AG system configurations D and E). The TD-LTE radio frame structure 3000-1 also includes extended special subframes that extend over subframes SF 6 and SF 7 (e.g., configuration A) and SF 8 (e.g., configuration D).

In this configuration, ACK/NACK feedback is received on the physical HARQ indicator channel (PHICH) assigned to a UE in a subframe n. This ACK/NACK feedback is associated with a physical uplink shared channel (PUSCH) transmission of data in an uplink subframe SF n-K₂. That is, the UE may detect ACK/NACK feedback on the PHICH assigned to the UE. In response, the UE associates the detected ACK/NACK feedback with the PUSCH transmission in the uplink subframe SF-k₂. In this configuration, the K₂ values may, for example, replace Table 8.3-1 in 3GPP TS 36.213. In this synchronous HARQ implementation, the K₂ values may be determined by a round trip time (RTT) and the K₁ values of, for example, FIGS. 29A and 29B as follows:

K₂=RTT−K₁ (7)

FIG. 30A illustrates various K₂ values for Next-Gen AG system configuration A, B, D and E according to one aspect of the present disclosure. In Next-Gen AG system configuration A, a value of K₂=7 is specified for downlink subframes SF 0 and SF 5 as well as special subframes SF 1 and SF 6. Similarly, in Next-Gen AG system configuration D, the value of K₂=7 is specified for special subframes SF 1 and SF 6. Based on this value of K₂, ACK/NACK feedback received in the downlink subframe SF 0 of the current radio frame is associated with a PUSCH transmitted (e.g., retransmitted) in an uplink subframe SF 3 of a previous radio frame (not shown). In addition, ACK/NACK feedback received in the special subframe SF 1 of the current radio frame is associated with a PUSCH transmitted in an uplink subframe SF 4 of the previous radio frame. Similarly, in Next-Gen AG system configuration D, ACK/NACK feedback received in the special subframe SF 1 of the current radio frame is associated with a PUSCH transmitted in an uplink subframe SF 4 of the previous radio frame.

In Next-Gen AG system configuration A, ACK/NACK feedback received in the downlink subframe SF 5 of the current radio frame is associated with a PUSCH transmitted in an uplink subframe SF 8 of the previous radio frame. In addition, ACK/NACK feedback received in the special subframe SF 6 of the current radio frame is associated with a PUSCH transmitted in an uplink subframe SF 9 of the previous radio frame. Similarly, in Next-Gen AG system configuration D, ACK/NACK feedback received in the special subframe SF 6 of the current radio frame is associated with a PUSCH transmitted in an uplink subframe SF 9 of the previous radio frame.

In Next-Gen AG system configuration B, a value of K₂=4 is specified for downlink subframes SF 7 and SF 8. Based on this value of K₂, ACK/NACK feedback received in the downlink subframe SF 7 of the current radio frame is associated with a PUSCH transmitted in an uplink subframe SF 3 of the current radio frame. In addition, ACK/NACK feedback received in the downlink subframe SF 8 of the current radio frame is associated with a PUSCH transmitted in an uplink subframe SF 4 of current radio frame. In addition, ACK/NACK feedback received in the downlink subframe SF 8 of the TD-LTE radio frame structure 3000-1 is associated with a data package transmitted in an uplink subframe SF 4 of the TD-LTE radio frame structure 3000-1. Similarly, in Next-Gen AG system configuration E, a value of K₂=6 is specified for a downlink subframe SF 8. Based on this value of K₂, ACK/NACK feedback received in downlink subframe SF 8 of the current radio frame is associated with a PUSCH transmitted in an uplink subframe SF 4 of the current radio frame.

FIG. 30B illustrates a configuration of a TD-LTE radio frame structure 3000-2 including ACK/NACK feedback received on a physical HARQ indicator channel (PHICH) when communicating with an extended special subframe. The TD-LTE radio frame structure 3000-2 has a twenty (20) millisecond periodicity with extended special subframes that extend over subframes SF 1, SF 2, subframes SF 6 and SF 7, and subframes SF 11 and SF 12 (e.g., Next-Gen AG system configuration C). In addition, extended special subframes extend over subframes SF 1 to SF 3, subframes SF 6 to SF 8, and subframes SF 11 to SF 13 (e.g., Next-Gen AG system configuration F).

In Next-Gen AG system configuration C, a value of K₂=12 is specified for downlink subframes SF 0, SF 5 and SF 15 as well as special subframes SF 1 and SF 6. In addition, a value of K₂=13 is specified for a downlink subframe SF 17. Based on the value of K₂=12, ACK/NACK feedback received in downlink subframe SF 0 of the current radio frame is associated with a PUSCH transmitted in an uplink subframe SF 8 of a previous radio frame structure (not shown). In addition, ACK/NACK feedback received in the special subframe SF 1 of the TD-LTE radio frame structure 3000-1 is associated with a PUSCH transmitted in an uplink subframe SF 9 of the previous radio frame structure.

In this example, ACK/NACK feedback received in downlink subframe SF 5 of the current radio frame is associated with a PUSCH transmitted in an uplink subframe SF 13 of a previous radio frame. In addition, ACK/NACK feedback received in the special subframe SF 6 of the current radio frame is associated with a PUSCH transmitted in an uplink subframe SF 14 of the previous frame. In addition, ACK/NACK feedback received in downlink subframe SF 15 of the current radio frame is associated with a PUSCH transmitted in an uplink subframe SF 3 of the current radio frame. Based on the value of K₂=13, ACK/NACK feedback received in downlink subframe SF 17 of the current radio frame is associated with a PUSCH transmitted in an uplink subframe SF 4 of the current radio frame.

In Next-Gen AG system configuration F, a value of K₂=12 is specified for special subframes SF 1 and SF 6. In addition, a value of K₂=13 is specified for a downlink subframe SF 17. Based on the value of K₂=12, ACK/NACK feedback received in the special subframe SF 1 of the current radio frame is associated with a PUSCH transmitted in an uplink subframe SF 9 of the previous the current radio frame. ACK/NACK feedback received in the special subframe SF 6 of the current radio frame is also associated with a PUSCH transmitted in an uplink subframe SF 14 of the previous the current radio frame. Based on the value of K₂=13, ACK/NACK feedback received in the downlink subframe SF 17 of the current radio frame is associated with a PUSCH transmitted in an uplink subframe SF 4 of the current radio frame.

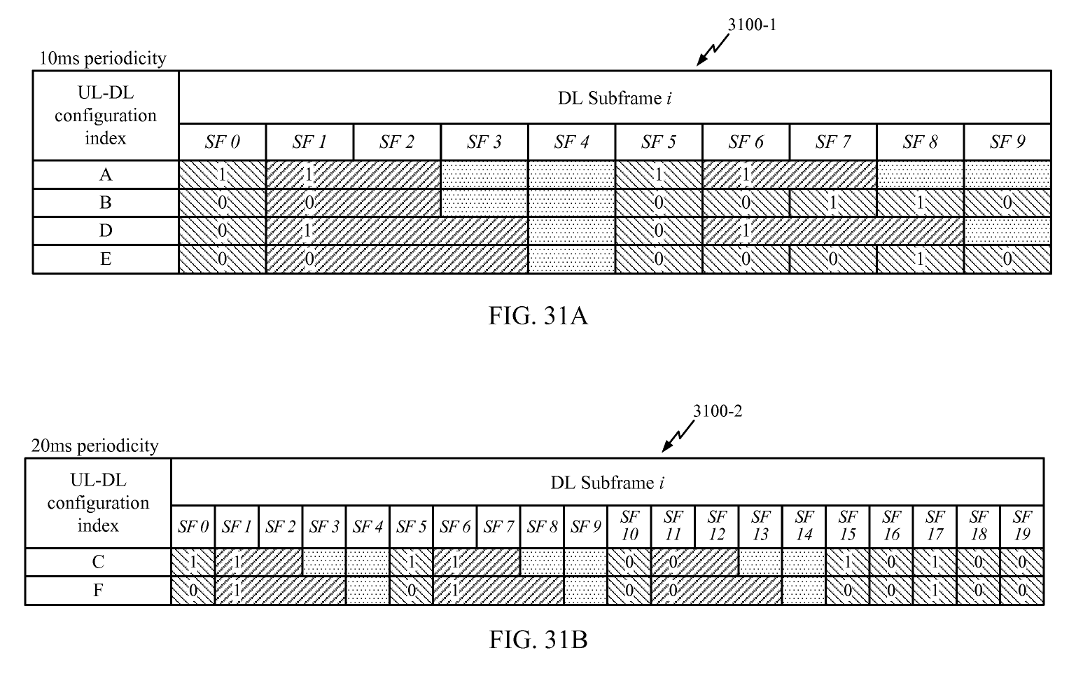

FIG. 31A illustrates a configuration of a TD-LTE radio frame structure 3100-1 including the factor mᵢ of the number of physical HARQ indicator channel (PHICH) groups for each downlink subframe when communicating with an extended special subframe. The TD-LTE radio frame structure 3100-1 also has a ten (10) millisecond periodicity with extended special subframes that extend over subframes SF 1, SF 2 (e.g., Next-Gen AG system configurations A and B) and also SF 3 (e.g., Next-Gen AG system configurations D and E). The TD-LTE radio frame structure 3100-1 also includes extended special subframes that extend over subframes SF 6 and SF 7 (e.g., configuration A) and SF 8 (e.g., configuration D).

In this configuration, the TD-LTE radio frame structure 3100-1 indicates whether the physical HARQ indicator channel (PHICH) assigned to a downlink or special subframe n. This ACK/NACK feedback is associated with a physical uplink shared channel (PUSCH) transmission of data in an uplink subframe SF n-K₂, as shown in FIG. 31A. In the Next-Gen AG system, the number of a PHICH group may vary between downlink subframes (or DwPTS) and is given by:

mᵢ·N_{PHICH}^{group} (8)

The PHICH group factor mᵢ is shown in the TD-LTE radio frame structure 3100-1. In this configuration, PHICH group factor mᵢ may, for example, replace Table 6.9-1 (mᵢ) in 3GPP TS 36.211. In this HARQ implementation, the PHICH index I_{PHICH} is set to zero (I_{PHICH}=0) because no multiple ACK/NACKs are configured for any downlink subframe for a single UE, for example, as specified in section 9.1.2 in 3GPP TS 36.213.

FIG. 31A illustrates various mᵢ values for Next-Gen AG system configurations A, B, D and E according to one aspect of the present disclosure. In Next-Gen AG system configuration A, a value of mᵢ=1 is specified for downlink subframes SF 0 and SF 5 as well as special subframes SF 1 and SF 6, indicating that PHICH is being assigned in theses subframes. Similarly, in Next-Gen AG system configuration D, the value of mᵢ=1 is specified for special subframes SF 1 and SF 6. This means that PHICH is assigned in the special subframes SF 1 and SF 6. A value of mᵢ=0, however, is specified for the downlink subframes SF 1 and SF 6 of in Next-Gen AG system configuration D. As a result, this implies that there is no PHICH being assigned in the downlink subframes SF 1 and SF 6.

In Next-Gen AG system configuration B, a value of mᵢ=0 is specified for downlink subframes SF 0, SF 5, SF 6 and SF 9 and a special subframe SF 1 of the TD-LTE radio frame structure 3100-1. This implies that there is no PHICH being assigned in the downlink subframes SF 0, SF 5, SF 6 and SF 9 and the special subframe SF 1. Similarly, in Next-Gen AG system configuration E, a value of mᵢ=0 is specified for downlink subframes SF 0, SF 5, SF 6, SF 7 and SF 9 as well as a special subframe SF 1 of the TD-LTE radio frame structure 3100-1. This implies that there is no PHICH being assigned in the downlink subframes SF 0, SF 5, SF 6, SF 7 and SF 9 as well as the special subframe SF 1.

In Next-Gen AG system configuration B, a value of mᵢ=1 is specified for downlink subframes SF 7 and SF 8 of the TD-LTE radio frame structure 3100-1. This means that PHICH is assigned in the downlink subframes SF 7 and SF 8. Similarly, in Next-Gen AG system configuration E, a value of mᵢ=1 is specified for downlink subframe SF 8 of the TD-LTE radio frame structure 3100-1. This means that PHICH is assigned in the downlink subframe SF 8.

FIG. 31B illustrates a configuration of a TD-LTE radio frame structure 3100—including the factor mᵢ of the number of physical HARQ indicator channel (PHICH) groups for each downlink subframe when communicating with an extended special subframe. The TD-LTE radio frame structure 3100-2 has a twenty (20) millisecond periodicity with extended special subframes that extend over subframes SF 1, SF 2, subframes SF 6 and SF 7, and subframes SF 11 and SF 12 (e.g., Next-Gen AG system configuration C). In addition, extended special subframes extend over subframes SF 1 to SF 3, subframes SF 6 to SF 8, and subframes SF 11 to SF 13 (e.g., Next-Gen AG system configuration F).

In Next-Gen AG system configuration C, a value of mᵢ=1 is specified for downlink subframes SF 0, SF 5, SF 15 and SF 17, as well as special subframes SF 1 and SF 6 of the TD-LTE radio frame structure 3100-2. This means that PHICH is assigned in the downlink subframes SF 1, SF 5, SF 15 and SF 17, as well as the special subframes SF 1 and SF 6. Similarly, in Next-Gen AG system configuration F, a value of mᵢ=1 is specified for special subframes SF 1 and SF 6 as well as a downlink subframe SF 17 of the TD-LTE radio frame structure 3100-1. This means that PHICH is assigned in the special subframes SF 1 and SF 6 as well as the downlink subframe SF 17.

In Next-Gen AG system configuration C, a value of mᵢ=0 is specified for downlink subframes SF 10, SF 16, SF 18 and SF 19, as well as a special subframe SF 11 of the TD-LTE radio frame structure 3100-2. This implies that there is no PHICH being assigned in the downlink subframes SF 10, SF 16, SF 18 and SF 19, as well as the special subframe SF 11. Similarly, in Next-Gen AG system configuration F, a value of mᵢ=0 is specified for downlink subframes SF 0, SF 5, SF 10, SF 15, SF 16, SF 18 and SF 19 as well as a special subframe SF 11 of the TD-LTE radio frame structure 3100-2. This implies that there is no PHICH being assigned in the downlink subframes SF 0, SF 5, SF 10, SF 15, SF 16, SF 18 and SF 19 as well as the special subframe SF 11.

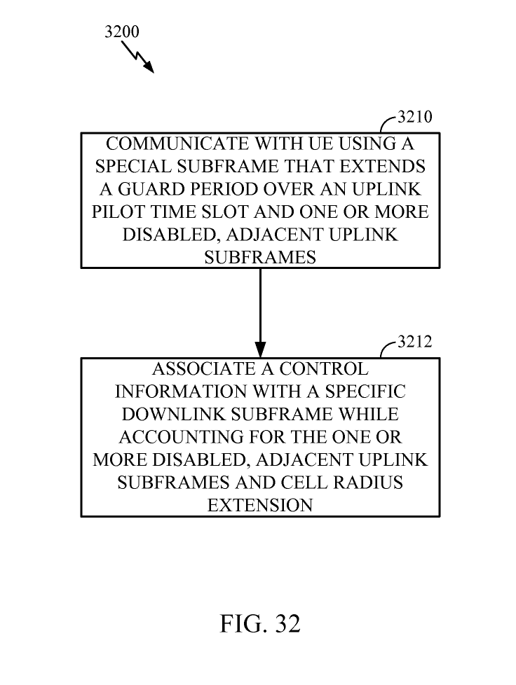

FIG. 32 illustrates a method 3200 for modification of a time division long term evolution (TD-LTE) frame structure according to an aspect of the present disclosure. In block 3210, an eNodeB communicates with the UE using a special subframe that extends a guard period over an uplink pilot time slot and one or more disabled, adjacent uplink subframes. In one configuration, this extended special subframe is used to communicate with a UE when a position of a UE is detected as being within a first extended cell radius or a second extended cell radius outside of a non-extended cell radius (e.g., less than one-hundred (100) kilometers). For example, a first extended cell radius may be greater than one-hundred (100) kilometers and less than or equal to two-hundred fifty kilometers. A second extended cell radius may be greater than two-hundred fifty kilometers.

For example, the eNodeB may communicate using a first extended special subframe when the position of the UE is within the first extended cell radius. In this example, (see FIGS. 16A to 17B) the eNodeB may also communicate using a second extended special subframe (see FIGS. 18A to 19B) when the position of the UE is within the second extended cell radius. In this example, a length of the second extended special subframe is greater than a length of the first extended special subframe because the second extended cell radius is greater than the first extended cell radius.

Referring again to FIG. 32, at process block 3212, a control information is associated with a specific downlink subframe while accounting for cell radius extension and loss of the one or more disabled, adjacent uplink subframes used to communicate the extended special subframe. In this configuration, the control information may be acknowledgement (ACK)/negative acknowledgement (NACK) feedback communicated during an uplink subframe. In this configuration, the ACK/NACK feedback communicated during the uplink subframe n corresponds to a PDSCH transmission in downlink subframe n-k.

For example, as shown in FIG. 25A, the specific downlink subframes (e.g., SF 9, SF 0 and SF 5) are determined according to an downlink association set index value (e.g., 14, 13, 8) within the uplink subframe (e.g., SF 3) according to a Next-Gen AG system configuration (e.g., B), so that the ACK/NACK feedback corresponding to PDSCH transmissions in the specific downlink subframes (SF 9, SF 0 and SF 5) can be communicated in the uplink subframe (SF 3). Alternatively, a PUSCH transmission in uplink subframe n corresponds to an uplink grant and/or a negative acknowledgement (NACK) communicated during a downlink subframe n-k. For example, as shown in FIG. 28A, an index value (e.g., 8) within an uplink subframe (e.g., SF 3) according to a Next-Gen AG system configuration (e.g., A) enables a UE to determine a downlink subframe (e.g., SF 5) that communicates an uplink grant or ACK/NACK feedback for the uplink subframe.

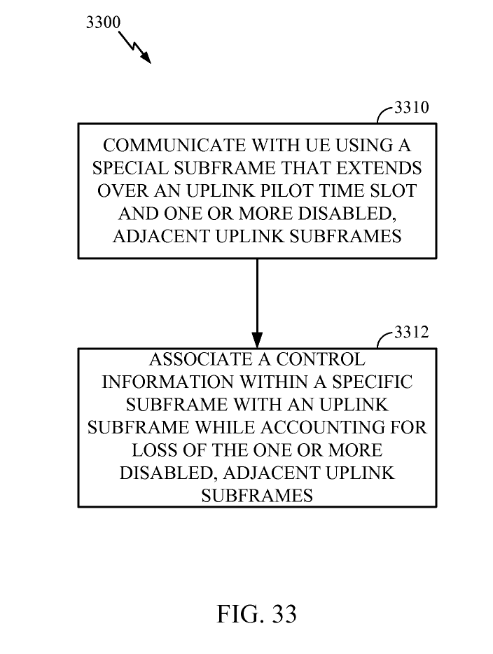

FIG. 33 illustrates a method 3300 for modification of a time division long term evolution (TD-LTE) frame structure according to another aspect of the present disclosure. In block 3310, an eNodeB communicates with the UE using a special subframe that extends over an uplink pilot time slot and one or more disabled, adjacent uplink subframes. At process block 3312, control information within a specific subframe is associated with an uplink subframe while accounting for loss of the one or more disabled, adjacent uplink subframes used to communicate the extended special subframe. In one configuration, the specific subframe may be a downlink subframe or a special subframe of an extended special subframe. In this configuration, the uplink subframe is determined according to an index value within the specific subframe.

For example, as shown in FIG. 30A, an index value (e.g., 7) within a specific subframe (e.g., SF 1) according to a Next-Gen AG system configuration (e.g., A) enables a UE to determine an uplink subframe (e.g., SF 4) to which an uplink grant communicated during the specific subframe corresponds. Alternatively, as shown in FIG. 31A, an uplink subframe (e.g., SF 8) to which ACK/NACK feedback communicated during a specific subframe (e.g., SF 0) corresponds is determined according to an index value (e.g., 8) within the specific subframe (e.g., SF 0) according to a Next-Gen AG system configuration (e.g., A).

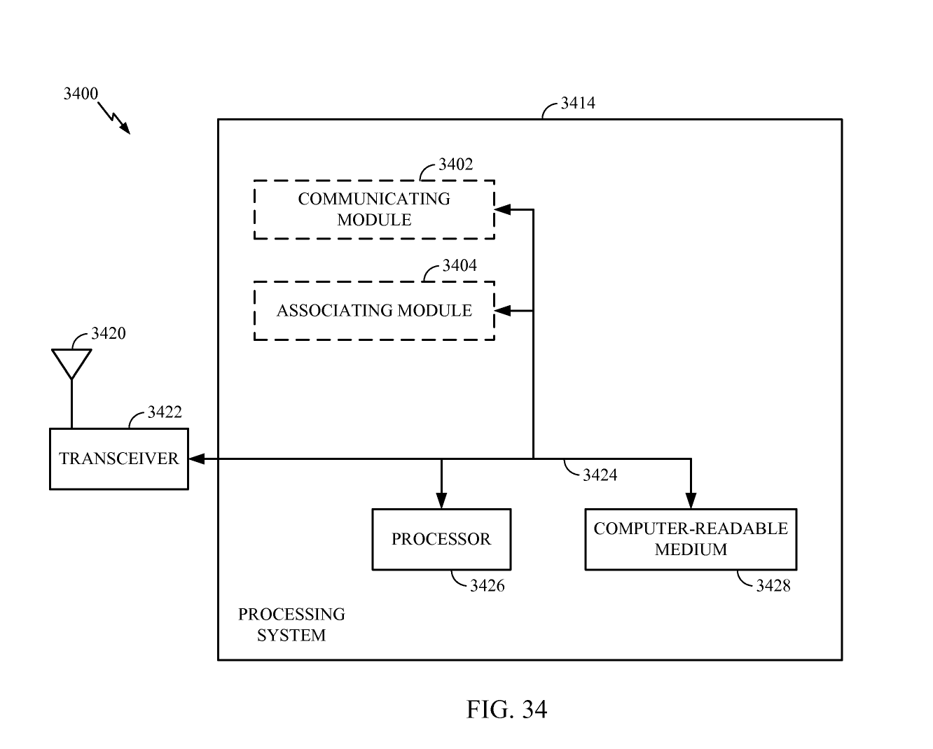

FIG. 34 is a diagram illustrating an example of a hardware implementation for an apparatus 3400 employing a Next-Gen AG system 3414 according to one aspect of the present disclosure. The Next-Gen AG system 3414 may be implemented with a bus architecture, represented generally by a bus 3424. The bus 3424 may include any number of interconnecting buses and bridges depending on the specific application of the Next-Gen AG system 3414 and the overall design constraints. The bus 3424 links together various circuits including one or more processors and/or hardware modules, represented by a processor 3426, a communicating module 3402, an associating module 3404, and a computer-readable medium 3428. The bus 3424 may also link various other circuits such as timing sources, peripherals, voltage regulators, and power management circuits, which are well known in the art, and therefore, will not be described any further.

The apparatus also includes a Next-Gen AG system 3414 coupled to a transceiver 3422. The transceiver 3422 is coupled to one or more antennas 3420. The transceiver 3422 provides a means for communicating with various other apparatus over a transmission medium. The Next-Gen AG system 3414 includes the processor 3426 coupled to the computer-readable medium 3428. The processor 3426 is responsible for general processing, including the execution of software stored on the computer-readable medium 3428. The software, when executed by the processor 3426, causes the Next-Gen AG system 3414 to perform the various functions described supra for any particular apparatus. The computer-readable medium 3428 may also be used for storing data that is manipulated by the processor 3426 when executing software.

The Next-Gen AG system 3414 includes the communicating module 3402 for communicating with the UE using a special subframe that extends over an uplink pilot time slot and one or more disabled, adjacent uplink subframes. The Next-Gen AG system 3414 further includes the associating module 3404 for associating a control information subframe with a specific down link subframe while accounting for loss of the one or more disabled, adjacent uplink subframes used to communicate the extended special subframe. Alternatively, the associating module 3404 is configured for associating control information of a specific subframe with an uplink subframe while accounting for loss of the one or more disabled, adjacent uplink subframes used to communicate the extended special subframe. The communicating module 3402 and the associating module 3404 may be software modules running in the processor 3426, resident/stored in the computer-readable medium 3428, one or more hardware modules coupled to the processor 3426, or some combination thereof. The Next-Gen AG system 3414 may be a component of the eNodeB 610 and/or the UE 650.

In one configuration, the apparatus 3400 for wireless communication includes means for communicating with and means for associating. The means may be the communicating module 3402, the associating module 3404 and/or the Next-Gen AG system 3414 of the apparatus 3400 configured to perform the functions recited by the communicating means and the associating means. In one aspect of the present disclosure, the communicating means may be the controller/processor 675 and/or memory 676, the transmit processor 616, and/or the transmitter 618 TX configured to perform the functions recited by the communicating means. In this aspect of the disclosure, the associating means may be the controller/processor 675 and/or memory 676 configured to perform the functions recited by the associating means. In another aspect, the aforementioned means may be any module or any apparatus configured to perform the functions recited by the aforementioned means.

The examples above describe aspects implemented in a TD-LTE system. Nevertheless, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
communicating with a base station using a special subframe that extends a guard period over an uplink pilot time slot and one or more disabled, adjacent uplink subframes; and
associating a control information subframe with a specific downlink subframe while accounting for both cell radius extension and loss of the one or more disabled, adjacent uplink subframes used to communicate the extended special subframe.

2. The method of claim 1, in which the control information subframe includes acknowledgement (ACK)/negative ACK (NACK) feedback or an uplink grant.

3. The method of claim 1, in which the specific subframe comprises a downlink subframe or a special subframe of an extended special subframe.

4. The method of claim 1, further comprising scheduling retransmission via a scheduling command transmitted on a physical downlink control channel (PDCCH).

5. The method of claim 1, further comprising disabling communication of a sounding reference signal and/or channel quality information during communication of the extended special subframe.

6. The method of claim 1, further comprising scheduling retransmission via a negative acknowledgement (NACK) transmitted on a physical hybrid automatic repeat request channel (PHICH).

7. The method of claim 1, further comprising dynamically adjusting a maximum hybrid automatic repeat request (HARD) process number according to an uplink/downlink configuration of the base station.

8. The method of claim 1, further comprising dynamically adjusting a physical random access channel (PRACH) response time to deal with the impact of cell radius extension and muting the uplink pilot time slot and the one or more adjacent uplink subframes.

9. The method of claim 1, further comprising selecting an index value to avoid association of an uplink grant or negative ACK (NACK) feedback (which triggers a PUSCH retransmission) with a subframe of the extended special subframe when muting uplink pilot time slot and the one or more adjacent uplink subframes.

10. The method of claim 1, further comprising:
determining one or more downlink subframes according to one or more index values associated within the uplink subframe; and
communicating acknowledgement (ACK)/negative ACK (NACK) feedback for
each of PDSCH transmissions of the downlink subframes during the uplink subframe.

11. The method of claim 1, in which the method is performed within an aircraft.

12. A method of wireless communication, comprising:
communicating with a user equipment (UE) using a special subframe that extends over a guard period over an uplink pilot time slot and one or more disabled, adjacent uplink subframes; and
associating control information of a specific subframe with an uplink subframe while accounting for both cell radius extension and loss of the one or more disabled, adjacent uplink subframes used to communicate the extended special subframe.

13. The method of claim 12, in which associating the control information comprises determining the uplink subframe according to an index value within the specific subframe.

14. The method of claim 13, in which the index value indicates whether acknowledgement (ACK)/negative ACK (NACK) feedback is being communicated in the specific subframe.

15. The method of claim 13, in which the control information comprises acknowledgement (ACK)/negative ACK (NACK) feedback or an uplink grant.

16. The method of claim 12, in which the specific subframe comprises a downlink subframe or a special subframe of the extended special subframe.

17. The method of claim 12, further comprising adjusting a transmission of the uplink subframe on a physical uplink shared channel (PUSCH) according to the control information.

18. The method of claim 12, further comprising determining the specific subframe including the control information corresponding to the uplink subframe according to an index value within the uplink subframe while accounting for both cell radius extension and loss of the one or more disabled, adjacent uplink subframes used to communicate the extended special subframe.

19. The method of claim 12, further comprising determining the specific subframe including the control information corresponding to the uplink subframe according to an index value within the uplink subframe while accounting for both cell radius extension and loss of the one or more disabled, adjacent uplink subframes used to communicate the extended special subframe.

20. An apparatus for wireless communication, comprising:
a memory; and
at least one processor coupled to the memory, the at least one processor being configured:
to communicate with a base station using a special subframe that extends a guard period over an uplink pilot time slot and one or more disabled, adjacent uplink subframes; and
to associate a control information subframe with a specific downlink subframe while accounting for both cell radius extension and loss of the one or more disabled, adjacent uplink subframes used to communicate the extended special subframe.

21. The apparatus of claim 20, in which the at least one processor is further configured to schedule retransmission via a scheduling command transmitted on a physical downlink control channel (PDCCH).

22. The apparatus of claim 20, in which the at least one processor is further configured to disable communication of a sounding reference signal and/or channel quality information during communication of the extended special subframe.

23. The apparatus of claim 20, in which the at least one processor is further configured to dynamically adjust a maximum hybrid automatic repeat request (HARD) process number according to an uplink/downlink configuration of the base station.

24. The apparatus of claim 20, in which the at least one processor is further configured to select an index value to avoid association of an uplink grant or negative ACK (NACK) feedback (which triggers a PUSCH retransmission) with a subframe of the extended special subframe when muting uplink pilot time slot and the one or more adjacent uplink subframes.

25. The apparatus of claim 20, in which the at least one processor is further configured:
to determine one or more downlink subframes according to one or more index values associated within the uplink subframe; and
to communicate acknowledgement (ACK)/negative ACK (NACK) feedback for
each of PDSCH transmissions of the downlink subframes during the uplink subframe.

26. An apparatus for wireless communication, comprising:
a memory; and
at least one processor coupled to the memory, the at least one processor being configured:
to communicate with a user equipment (UE) using a special subframe that extends over a guard period over an uplink pilot time slot and one or more disabled, adjacent uplink subframes; and
to associate control information of a specific subframe with an uplink subframe while accounting for both cell radius extension and loss of the one or more disabled, adjacent uplink subframes used to communicate the extended special subframe.

27. The apparatus of claim 26, in which the at least one processor configured to associate the control information is further configured to determine the uplink subframe according to an index value within the specific subframe.

28. The apparatus of claim 26, in which the at least one processor is further configured to adjust a transmission of the uplink subframe on a physical uplink shared channel (PUSCH) according to the control information.

29. The apparatus of claim 26, in which the at least one processor is further configured to determine the specific subframe including the control information corresponding to the uplink subframe according to an index value within the uplink subframe while accounting for both cell radius extension and loss of the one or more disabled, adjacent uplink subframes used to communicate the extended special subframe.

30. The apparatus of claim 26, in which the at least one processor is further configured to determine the specific subframe including the control information corresponding to the uplink subframe according to an index value within the uplink subframe while accounting for both cell radius extension and loss of the one or more disabled, adjacent uplink subframes used to communicate the extended special subframe.
